(19) United States
(12) Patent Application Publication
(10) Pub. No.: US 2010/0241541 A1
(43) Pub. Date: Sep. 23, 2010

(54) BILLING DEVICE FOR IMAGE PROCESSING DEVICE WHICH ALLOCATES CHARGE AMONG A PLURALITY OF AUTHENTICATION MEDIA

(75) Inventors: Hiroyasu ITO, Okazaki-shi (JP); Ichiro Bessho, Okazaki-shi (JP); Harumitsu Fujimori, Machida-shi (JP); Tsutomu Ohata, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/720,955

(22) Filed: Mar. 10, 2010

(30) Foreign Application Priority Data
Mar. 23, 2009 (JP) 2009-070742

(51) Int. Cl. G06Q 30/00

(52) U.S. Cl. 705/34; 705/412

(57) ABSTRACT

An authentication printing function is performed in a multi function peripheral (MFP). A user transmits a job from a PC to the MFP, and then performs card authentication by bringing cards close to an authentication device. Authenticated-user information is transmitted to the MFP, where the authenticated users are registered. A print job is generated, and a billing scenario is generated in which a charge is allocated among the plurality of authenticated users on the basis of a billing pattern. When the billing scenario is approved by the user, the job is executed, and the authenticated users are each billed for the charge allocated thereto on a per-page or per-set basis, in accordance with the billing scenario. Accordingly, a billing device for an image processing device which can allocate a charge among a plurality of users without the need of complicated operations is provided.

This application is based on Japanese Patent Application No. 2009-070742 filed with the Japan Patent Office on Mar. 23, 2009, the entire content of which is hereby incorporated by reference.

### BACKGROUND OF THE INVENTION

1. Field of the Invention

The present invention relates to a billing device for an image processing device, and more particularly to a billing device for an image processing device which performs an accounting process in relation to charges levied according to operations of the image processing device.

2. Description of the Related Art

There is known a billing device for an image processing device (such as a multi function peripheral (MFP) provided with the scanner function, facsimile transmitting/receiving function, copying function, function as a printer, data communicating function, and server function, a facsimile machine, a copier, a printer, a scanner, and the like) which performs an accounting process in relation to charges levied according to the operations of the image processing device. Such a billing device may be used to charge cost to a user who uses the image processing device.

An image processing device may be provided with a user authentication function of identifying and authenticating a user. For the user authentication, a user ID and a password input via an operation panel may be used. Card authentication is also known, for which a contactless IC card or the like is used. Such user authentication guarantees a high level of security for the image processing device.

Document 1 below discloses an image forming device in which, when authentication is performed successfully for a plurality of contactless cards, accesses to storage areas (BOXes) corresponding to the cards are granted. In this image forming device, it is unnecessary to provide a plurality of card slots for the purposes of authenticating a plurality of users.

Document 2 below discloses a management system for an image forming device in which a card for use in charging cost is provided with a plurality of areas and the order of precedence of subtracting the charge is determined for the areas. In this management system, when the balance in the area from which the charge is supposed to be subtracted first becomes zero or insufficient, all or part of the charge is subtracted from another area.

### [Document 1] Japanese Patent Application Laid-Open No. 2007-299254

### [Document 2] Japanese Patent Application Laid-Open No. 2007-065211

The above-described billing function by the billing device for the image processing device may be used together with the user authentication function. At this time, the image processing device bills a user who performed a job for a predetermined charge. This makes it possible to grasp the exact amount of use of the image processing device by each user, and hence, to bill each user for the charge in accordance with the amount of use. This also prevents wasteful use of the image processing device by the users.

In the case where a single image processing device is used to perform processes for a plurality of users, it will be troublesome for each user to perform the authentication process to cause the image processing device to execute the process. Thus, it is often the case where one user uses the image processing device on behalf of the other users. If the billing process is carried out as described above in this case, however, the user who uses the image processing device will be billed for all the costs including the costs for the other users, resulting in the huge costs borne by the user who performs the processes including those for the other users.

A specific example of such a problem will now be described in conjunction with an image forming device having an authentication printing function (also referred to as a “touch-and-print function”) which is an example of the image processing device provided with the user authentication function. Here, the authentication printing function is carried out as follows. The user firstly transmits a print job from a personal computer (PC) to the image forming device. At this time, the image forming device stores the received job, without printing the same. Thereafter, once the user performs the above-described user authentication, the image forming device starts printing the stored job. This allows the user to readily perform the authentication printing function with simple procedure, while ensuring a high level of security.

Now assume that such an image forming device is used to print out a plurality of copies of a document so as to distribute one copy for each of a plurality of users. In this case, a certain user transmits a job from a PC to the image forming device, the job being set such that a plurality of copies are to be printed out, and the user performs user authentication to cause the image forming device to output a plurality of copies including those for the other users. At this time, the costs for all the printouts are charged to the user who performed the job, i.e., the user who performed the user authentication. For example in the case of Document 2 above, when a plurality of copies are printed out for a plurality of users, the entire printing cost is subtracted from the card of the user who performed the job.

To address the above-described problem, the users who are supposed to be billed, i.e., the users to whom the printouts are to be distributed, may each transmit a job to the image forming device in advance. In this case, the billing device is capable of identifying that the printouts are for the respective users, and thus, it can appropriately bill the respective users for the corresponding charges for the printouts. In this case, however, a plurality of jobs need to be transmitted from the respective PCs to the image forming device, which takes a longer time until all the copies are printed out. Furthermore, a setting operation by a user is required every time a job is transmitted, which deteriorates the ease of operation of the touch-and-print function.

Neither Document 1 nor Document 2 above discloses any effective solution to these problems.

### SUMMARY OF THE INVENTION

The present invention has been accomplished to solve the foregoing problems, and an object of the present invention is to provide a billing device for an image processing device which can distribute a charge among a plurality of users, without the need of complicated operations.

To achieve the above object, according to an aspect of the present invention, a billing device for an image processing device performs an accounting process in relation to a charge levied according to an operation of the image processing device, wherein the billing device includes: a determining unit configured to determine that a plurality of authentication media have been detected simultaneously or within a predetermined period of time; and an allocating unit configured to allocate, among the plurality of authentication media determined to be detected by the determining unit, a predetermined charge levied according to the operation of the image processing device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of an MFP (as an example of the image processing device) according to a first embodiment of the present invention;

FIG. 2 is a block diagram showing an internal configuration of the MFP;

FIG. 3 is a block diagram showing an internal configuration of a PC;

FIG. 4 is a side view of an authentication device which is reading a plurality of cards;

FIG. 5 shows, by way of example, jobs stored in an image storage unit;

FIG. 6 is a flowchart illustrating a flow of a PC print job registration process;

FIG. 7 shows an authenticated-user management table;

FIG. 8 is a flowchart illustrating a flow of a post-authentication printing operation;

FIG. 9 is a sequence diagram showing the operations of the MFP and the authentication device related to billing, which are performed before the printing job is started;

FIG. 10 is a sequence diagram showing the operations of the MFP related to billing, which are performed after the printing job is started;

FIG. 11 is a flowchart illustrating the operations of the MFP in a billing scenario generating process;

FIGS. 12 to 18 show billing patterns A to G, respectively;

FIG. 19 shows a display and operation unit on which a billing scenario confirmation screen is displayed;

FIG. 20 is a flowchart illustrating an example of the billing process (first billing process);

FIG. 21 is a flowchart illustrating another example of the billing process (second billing process);

FIG. 22 shows, by way of example, an alarm screen displayed when funds are insufficient; and

FIGS. 23 and 24 show, by way of example, the operations of the MFP performed for handling the insufficient funds.

### DESCRIPTION OF THE PREFERRED EMBODIMENTS

Hereinafter, a billing device for an image processing device according to an embodiment of the present invention will be described.

The billing device for an image processing device is used for a multi function peripheral (MFP) which is provided with the scanner function, the copying function, the function as a printer, the facsimile transmitting/receiving function, the data communicating function, and the server function. Such an MFP (as an example of the image processing device) is called a digital composite machine. With the scanner function, the MFP reads an image from a document that has been set, and stores image data in a hard disk drive (HDD) or the like. With the copying function, it prints the image on a sheet of paper or the like. With the function as a printer, it receives a print instruction from an external terminal such as a personal computer (PC) and performs printing on a sheet of paper based on the instruction. With the facsimile transmitting/receiving function, it receives facsimile data from an external facsimile machine or the like and stores the data in the HDD. With the data communicating function, it transmits and receives data to and from an external device connected thereto. With the server function, it allows a plurality of users to share the data stored in the HDD and the like.

The billing device may be used to charge for the use of the image processing device such as the MFP described above, for management of the image processing device.

### Embodiment

### (1) Configuration of MFP (as an Example of the Image Processing Device)

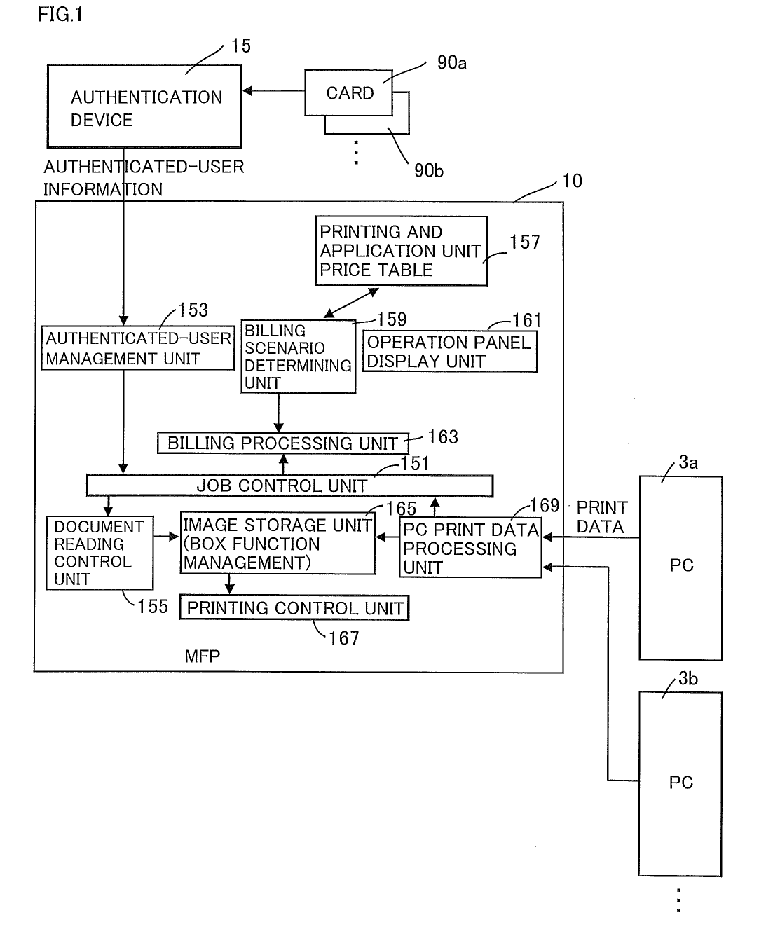

Referring to FIG. 1, an MFP 10 is connected with an authentication device 15. MFP 10 is also connected with external devices such as PCs 3a, 3b, . . . MFP 10 and PCs 3a, 3b, . . . are communicable with each other. Authentication device 15 is capable of detecting cards (as examples of the authentication medium) 90a, 90b, . . . (hereinafter, they may also be referred to as a “card 90”). Authentication device 15 reads information from card 90, and transmits authenticated-user information to MFP 10. This allows a central processing unit (CPU) 101 included in MFP 10 to determine that card 90 has been detected.

MFP 10 includes a job control unit 151, an authenticated-user management unit 153, a document reading control unit 155, a printing and application unit price table 157, a billing scenario determining unit 159, an operation panel display unit 161, a billing processing unit 163, an image storage unit (BOX function management unit) 165, a printing control unit 167, and a PC print data processing unit 169. These units in MFP 10 execute predetermined functions of MFP 10 under the control of CPU 101, as will be described later.

Authentication device 15 is, e.g., a contactless IC card reader. Authentication device 15 may perform radio communication, or contactless communication, with card 90. Authentication device 15 includes an antenna and a radio circuit for generating a magnetic field for communicating with card 90, and a circuit for demodulating and decoding received information. Authentication device 15 is also provided with a communication module such as a universal serial bus (USB) interface. Authentication device 15 is connected to MFP 10 via a USB cable or the like, whereby authentication device 15 is connected to MFP 10 in a communicable manner.

When cards 90a, 90b, . . . are brought close to authentication device 15, authentication device 15 detects them. Authentication device 15 reads information stored in the detected cards 90a, 90b, . . . , and performs card authentication, as will be described later. A CPU included in authentication device 15 transmits the information read from cards 90a, 90b, . . . to MFP 10.

Card 90 is, e.g., a contactless IC card. An IC unit (not shown) and an antenna (not shown) are embedded in card 90. When card 90 is brought close to the antenna of authentication device 15, electromagnetic induction takes place in authentication device 15, so that a current is generated on the antenna of card 90. The IC unit is driven by the current as a power supply. The IC unit, when driven, modulates the information stored in the IC unit and outputs radio waves via the antenna. Authentication device 15 receives and demodulates the radio waves to thereby read the information stored in card 90.

Card 90 stores, in advance, a card ID (ID number) and user attribute information. The user attribute information includes authentication information such as a user ID and a password, and information about user's affiliation. Card 90 is passed to each user of MFP 10 for use as an authentication medium for the user, as will be described later.

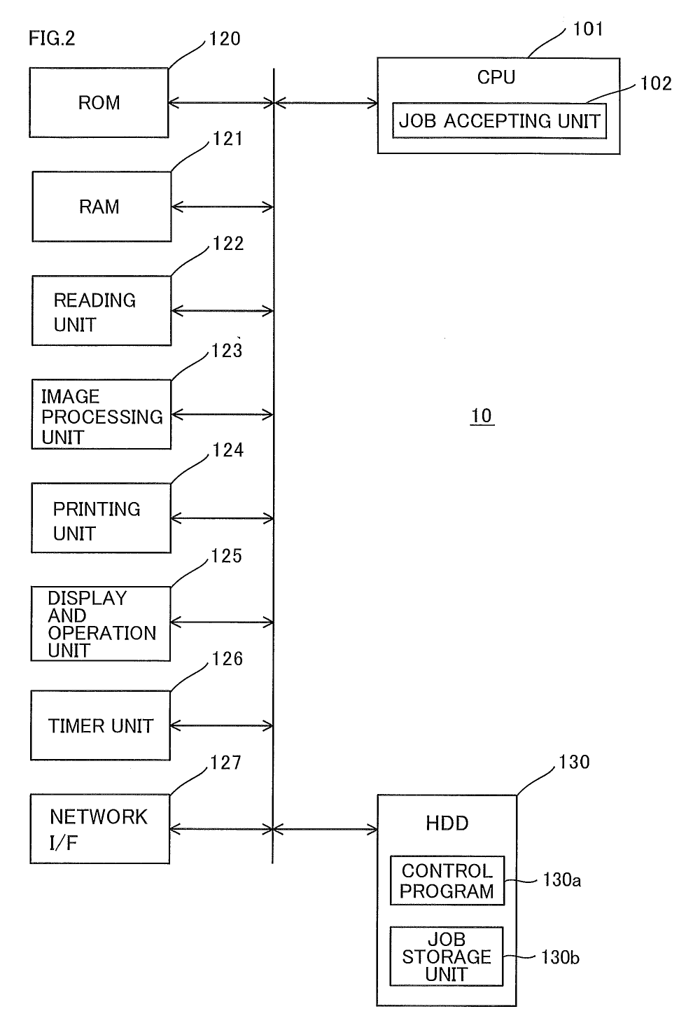

FIG. 2 shows the internal configuration of MFP 10.

As shown in FIG. 2, MFP 10 includes CPU 101, a read only memory (ROM) 120, a random access memory (RAM) 121, a reading unit 122, an image processing unit 123, a printing unit 124, a display and operation unit (display) 125, a timer unit 126, a network interface (I/F) 127, and a HDD 130.

CPU 101 reads a necessary program from ROM 120. CPU 101 is responsible for overall control of operation timings of the respective units. CPU 101 performs various control operations for scan jobs, copy jobs, and print jobs.

ROM 120 stores various programs for job processing and the like and various fixed data.

RAM 121 is a volatile memory. RAM 121 is used as a work memory while CPU 101 is executing a program. RAM 121 is also used as a paged memory to store at least one page of image data for rotation processing and the like.

Reading unit 122 includes a light source for illuminating a document with light, a line image sensor for reading a line of the document in the width direction of the document, a shifting mechanism for shifting the per-line reading position in the length direction of the document, and an optical path made up of a lens, a mirror, and others for guiding the light reflected from the document toward the line image sensor so as to form an image. Reading unit 122 reads the image of the document to thereby generate image data corresponding thereto. Reading unit 122 uses an auto document feeder (ADF) to sequentially take in a plurality of documents set in a document tray, to generate image data corresponding thereto. The generated image data is converted into an application data format by CPU 101, for example, and is stored in HDD 130 or the like. CPU 101 is capable of transmitting the image data, stored in HDD 130 or the like, to PCs 3a, 3b, . . . .

The line image sensor is composed of a charge coupled device (CCD). The line image sensor outputs an analog image signal, which is A/D-converted into a digital image signal.

Image processing unit 123 performs scaling and rotation of images, as well as compression and expansion of images.

Printing unit 124 includes a recording-paper feeding unit, a photosensitive drum, a charger unit, a laser unit, a developing unit, a transfer and separation unit, a cleaning unit, and a fixing (fuser) unit. Printing unit 124 performs an electrophotographic process to form and output an image corresponding to the image data on a sheet of recording paper.

Display and operation unit 125 includes a liquid crystal display, provided with a touch panel on its surface, and various operation switches. Display and operation unit 125 provides a user with various displays of guidance, status, and error notifications. Display and operation unit 125 also accepts operations from the user.

Timer unit 126 keeps current date and time. Even when MFP 10 is turned off, timer unit 126 constantly keeps the data with a dedicated backup power supply.

Network I/F 127, in accordance with instructions from CPU 101, transmits data to and receives data from an external device via a local area network (LAN) or the like, by a communication protocol such as TCP/IP.

HDD 130 stores data such as print data externally received via network I/F 127, and the image data read by reading unit 122. HDD 130 also stores an authenticated-user management table (FIG. 7) for use in card authentication, as will be described later, and setting information for MFP 10.

CPU 101 is provided with a job accepting unit 102 for accepting a job. Job accepting unit 102 accepts a job from an external device such as PC 3a.

HDD 130 includes an area 130a for storing a control program of MFP 10, and a job storage unit 130b for storing the job that is received from PC 3a, 3b or the like and accepted by job accepting unit 102.

### (2) Configuration of PC 3

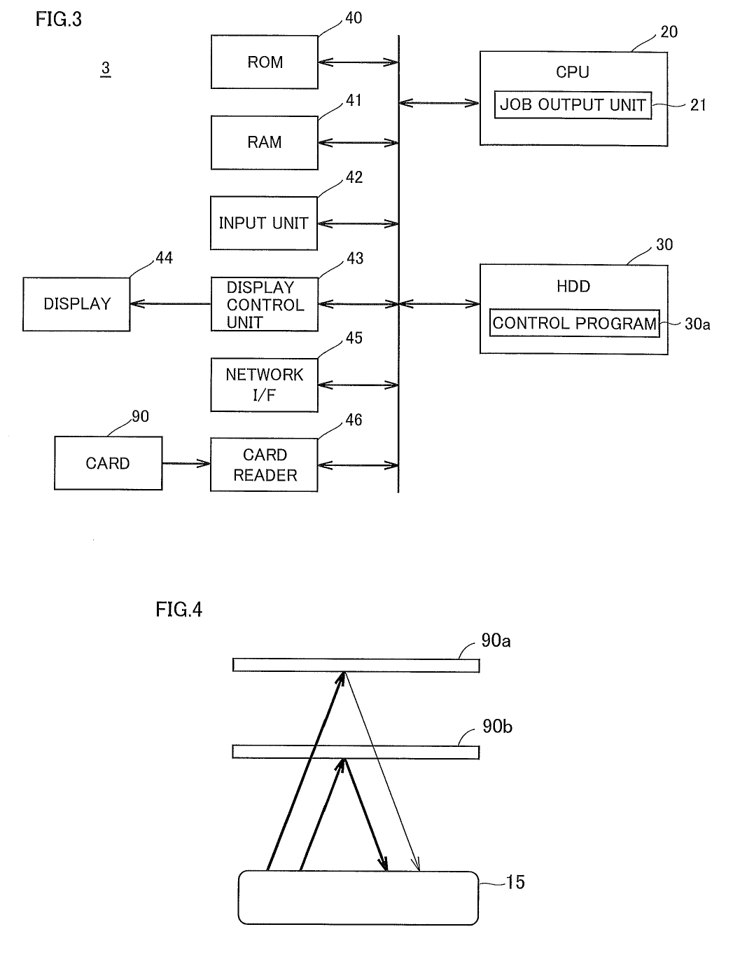

FIG. 3 shows the internal configuration of PC 3 (PCs 3a, 3b, . . . ).

As shown in FIG. 3, PC 3 includes a CPU 20, a HDD 30, a ROM 40, a RAM 41, an input unit 42, a display control unit 43, a display 44, a network I/F 45, and a card reader 46.

CPU 20 is responsible for overall control of PC 3.

ROM 40 stores a basic input/output system (BIOS) and a boot program. RAM 41 is a volatile memory and serves as a work area when CPU 20 executes a program.

HDD 30 stores, among others, an operating system (OS), an application program, a driver, various programs, and data files.

Input unit 42 is an input device including a keyboard and a mouse. Display control unit 43, under the control of CPU 20, stores in a video memory the data of an image to be drawn, and outputs the image data stored in the video memory as a video signal. Display 44 is a display device, which may be a cathode ray tube (CRT) or a liquid crystal display.

Network I/F 45 transmits data to and receives data from external devices such as MFP 10 and another PC 3 via a LAN or the like, by a communication protocol such as TCP/IP.

Card reader 46 is capable of reading card 90 and the like. Card 90 stores the user attribute information, as described above. CPU 20 refers to the attribute information read from card 90 by card reader 46, to determine whether the user who possesses that card 90 is permitted to use that PC 3. Card reader 46 may be configured to read the same card as card 90 that is read by authentication device 15, or may be configured to read another authentication medium, such as a magnetic card or an IC card (irrespective of whether it is a contact type or a non-contact type), or a mobile phone or a memory device in place of the card.

CPU 20 is provided with a job output unit 21. Job output unit 21 transmits document data to MFP 10.

HDD 30 includes an area 30a for storing a control program which can be executed by CPU 20.

When PC 3 is turned on, CPU 20 loads the OS from HDD 30 to RAM 41, in accordance with the boot program in ROM 40. CPU 20 also loads various device drivers. CPU 20 further loads the control program from HDD 30 to RAM 41 for execution. CPU 20 causes a printer driver for MFP 10, for example, to run on PC 3.

### (3) Card Authentication Function

FIG. 4 shows authentication device 15 which is reading a plurality of cards 90a and 90b.

As shown in FIG. 4, authentication device 15 is capable of reading a plurality of cards 90 almost at the same time. Now assume that two cards 90a and 90b, stacked on one another, are brought close to the reading unit of authentication device 15. When detecting that cards 90a and 90b are brought close thereto, authentication device 15 outputs radio waves to cards 90a and 90b so as to drive them. Cards 90a and 90b each output radio waves including the information stored in the card. Authentication device 15 receives the radio waves output from the respective cards 90a and 90b to read the information from the cards. While two cards 90a and 90b are shown in FIG. 4, in the case where one card 90 or three or more cards 90 are brought close as well, authentication device 15 reads information from the respective cards 90.

At this time, CPU 101 determines the stacked order of cards 90a and 90b on the basis of information, transmitted from authentication device 15, about the intensities of the radio waves received from the respective cards or about the times of reception of the radio waves from the respective cards. For example, assume that card 90a is located more distant from authentication device 15 than card 90b, as shown in FIG. 4. At this time, the intensity of the radio waves output from card 90a and received at authentication device 15 is lower than the intensity of the radio waves output from card 90b and received at authentication device 15. The time taken from when authentication device 15 outputs the radio waves to when the radio waves return to authentication device 15 is longer for card 90a than for card 90b. CPU 101 determines that card 90a is more distant from authentication device 15 than card 90b in accordance with these conditions at the time of reading cards 90a and 90b.

Here, authentication device 15 has a card authentication function of identifying and authenticating card 90. That is, authentication device 15 authenticates card 90 to thereby authenticate a user corresponding to that card 90, such as a user who possesses the card 90. MFP 10 uses the card authentication function to restrict the use of each function of MFP 10 for each user. MFP 10 also uses the card authentication function to perform an authentication printing function. The authentication printing function (touch-and-print function) refers to the function with which, when a user performs card authentication in the state where jobs have been stored, the job corresponding to that user is output. MFP 10 provided with the card authentication function guarantees a higher level of security. In the case where a plurality of cards 90 stacked on one another are brought close to authentication device 15, as described above, authentication device 15 performs card authentication for each of the read cards 90.

To perform the card authentication, authentication device 15 uses the user attribute information and the card ID read from card 90, and registration information acquired, e.g., from MFP 10. The registration information is information registered in advance in MFP 10. As the registration information, a user ID and a card ID of the authentication card possessed by that user are recorded for each user. That is, authentication device 15 determines whether the pair of user ID and card ID extracted from the user attribute information matches the pair of user ID and card ID included in the registration information, to perform the card authentication of the user. The registration information is registered, e.g., in an authenticated-user management table, which is stored in advance in HDD 130 or the like.

In the present embodiment, when a plurality of authentication cards 90 are detected within a predetermined period of time, it is considered that a plurality of users have performed card authentication at the same time (which may be called “simultaneous authentication”). There are largely two cases of simultaneous authentication: first simultaneous authentication and second simultaneous authentication. The first simultaneous authentication corresponds to the case where a certain user stacks a plurality of cards 90 for the plurality of users on one another, and brings the bunch of cards close to authentication device 15, as described above. The second simultaneous authentication corresponds to the case where a plurality of users perform card authentication consecutively. In the first simultaneous authentication, the plurality of cards 90 are read by authentication device 15 approximately simultaneously and authenticated. In the second simultaneous authentication, the plurality of cards 90 are not read simultaneously in the strict sense. However, if card authentication of one user is followed by card authentication of another user within a predetermined period of time (within ten seconds, for example), CPU 101 determines that the two cards have been authenticated simultaneously. Thus, for example in the case where three users perform card authentication at an interval of a predetermined time or less between the first user and the second user and between the second user and the third user, the second simultaneous authentication is fulfilled for cards 90 of the three users. In the following, it may be determined that the simultaneous authentication for a plurality of cards 90 has been accomplished only when the first or second simultaneous authentication is performed. In the case where the first simultaneous authentication and the second simultaneous authentication are performed consecutively within a predetermined period of time (within ten seconds, for example), it may be determined that the simultaneous authentication has been achieved for all the authentication cards 90 that are detected in the first and second simultaneous authentication. The determination as to whether the simultaneous authentication has been accomplished may be made by authentication device 15.

The card authentication may be performed at MFP 10. In this case, for example, CPU 101 may perform the card authentication by checking the user attribute information and the card ID corresponding to card 90, which have been read by authentication device 15 and transmitted to MFP 10, against an authenticated-user management table. The authenticated-user management table may be stored in a server (not shown) connected to the external network or in authentication device 15, and the registration information may be registered in that table. Alternatively, authentication device 15 or MFP 10 may refer to an authentication table that is different from the authenticated-user management table as will be described later, to perform the card authentication on the basis of the registration information included in the authentication table. In this case, the authentication table may be stored in any of MFP 10, the external server, and authentication device 15.

### (4) Authentication Printing Function (Touch-and-Print Function)

MFP 10 has the authentication printing function which utilizes the card authentication function by authentication device 15. In the authentication printing function, a PC print job registration process is performed, which is followed by a post-authentication printing operation. The PC print job registration process is performed prior to the card authentication. With the PC print job registration process, jobs are registered (stored) in image storage unit 165. The post-authentication printing operation is carried out as card 90 is read by authentication device 15. With the post-authentication printing operation, the registered jobs are executed and printed out in accordance with the result of the card authentication.

The PC print job registration process will now be described.

FIG. 5 shows, by way of example, jobs stored in image storage unit 165.

Image storage unit 165 is implemented as a function of MFP 10 by, e.g., HDD 130, CPU 101 and others. In image storage unit 165, jobs transmitted from PC 3 and the like are stored by the PC print job registration process. The image data read by reading unit 122 and the data received by the facsimile receiving function are also stored in image storage unit 165.

Here, image storage unit 165 has a function of managing a plurality of BOXes (storage areas) as data storage locations. Each BOX is set in association with an individual user or a group of predetermined users. For example, a BOX for a user A, a BOX for a user B, and a BOX (not shown) for a group including users A and B are provided. Each BOX may store data for a plurality of jobs. For example, as shown in FIG. 5, image storage unit 165 stores two jobs A1 and A2 in the BOX for user A and a job B1 in the BOX for user B. When job data is transmitted from PC 3 or image data is read by reading unit 122, CPU 101 stores the data in the BOX that is associated with the user who has designated the data transmission or the data reading. In this manner, the data may be stored in image storage unit 165 in a classified and organized manner, in association with each user. CPU 101 restricts access to each BOX in accordance with the presence/absence of authentication or the like. This ensures security of the data stored in the BOXes. CPU 101 may move or duplicate the data between the BOXes.

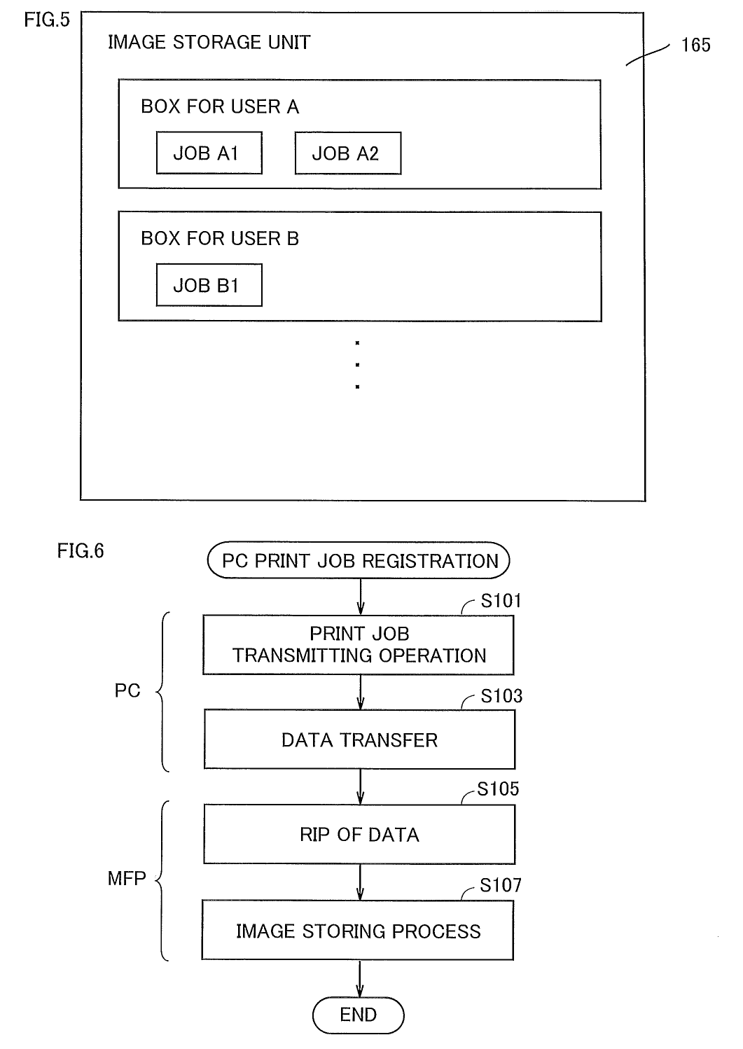

FIG. 6 is a flowchart illustrating a flow of the PC print job registration process.

In step S101, a user performs an operation of transmitting a job to MFP 10 (for registration) while an application program is running on PC 3. The transmitting operation is performed via a printer driver which is called by the application program in PC 3. The printer driver (or CPU 20 that operates by the printer driver; the same applies hereinafter) accepts the user operation in step S101.

In step S103, the printer driver in PC 3 transfers the job data for which the transmitting operation has been performed, to MFP 10. At this time, the printer driver associates information about the BOX which corresponds to the user who performed the transmitting operation, with the job data to be transferred. Specifically, the information about the BOX corresponding to the user who performed the transmitting operation, which is written in a page description language, is included in the data to be transmitted.

Step S105 is performed in MFP 10. When job accepting unit 102 included in CPU 101 receives the job data from PC 3, PC print data processing unit 169 performs raster image processing (RIP) of the data. Specifically, the RIP of the data is performed by CPU 101, RAM 121, and others.

In step S107, PC print data processing unit 169 performs an image storing process. The image storing process is the operation of storing the job data in one of the BOXes in image storage unit 165. At this time, PC print data processing unit 169 stores the data that has undergone the RIP, in the BOX designated by the received job data. Specifically, the image storing process is performed, e.g., by CPU 101, RAM 121, and others.

When the above-described processes are finished, the PC print job registration process is terminated. That is, MFP 10 does not execute the received job immediately. Rather, MFP 10 enters a standby mode, without performing the printing operation.

The post-authentication printing operation will now be described.

FIG. 7 shows an authenticated-user management table.

The authenticated-user management table includes a record for each of the users for whom authentication should be performed with respect to MFP 10. In the authenticated-user management table, a card ID (ID number) of card 90 possessed by a user, user attribute information (user attributes) of the user, and a billing pattern to be applied to the user are registered in association with the user. The billing pattern will be described later. As the user attribute information, a user ID and information about the user's affiliation, as well as information about the use limits on MFP 10, are registered for each card 90. Authentication information is also registered as the user attribute information.

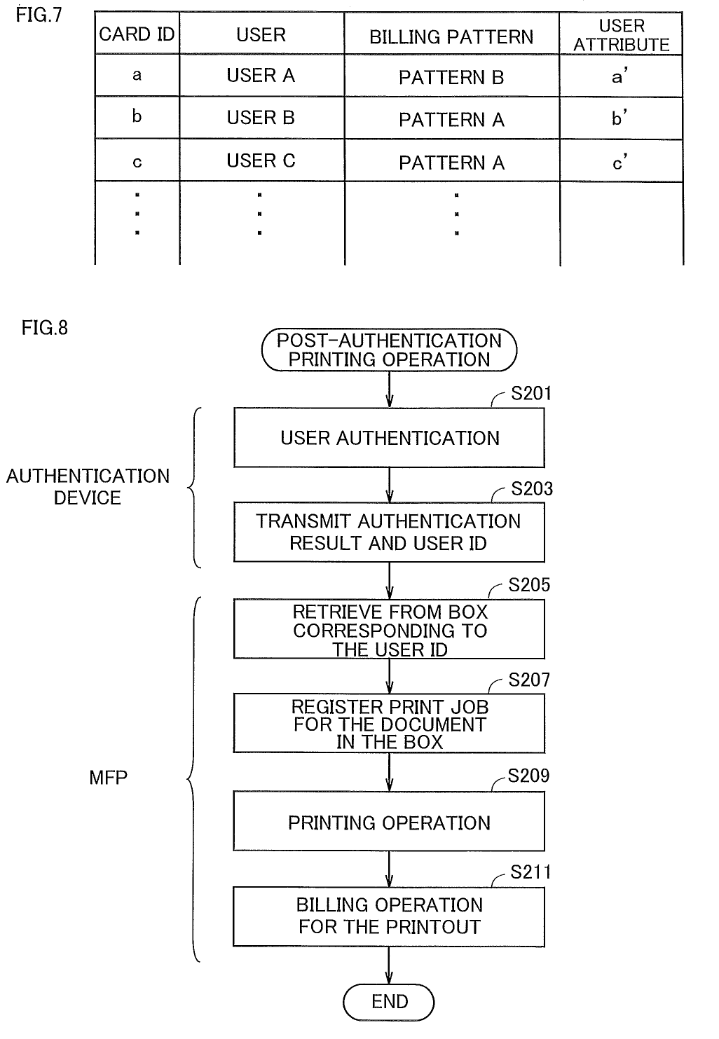

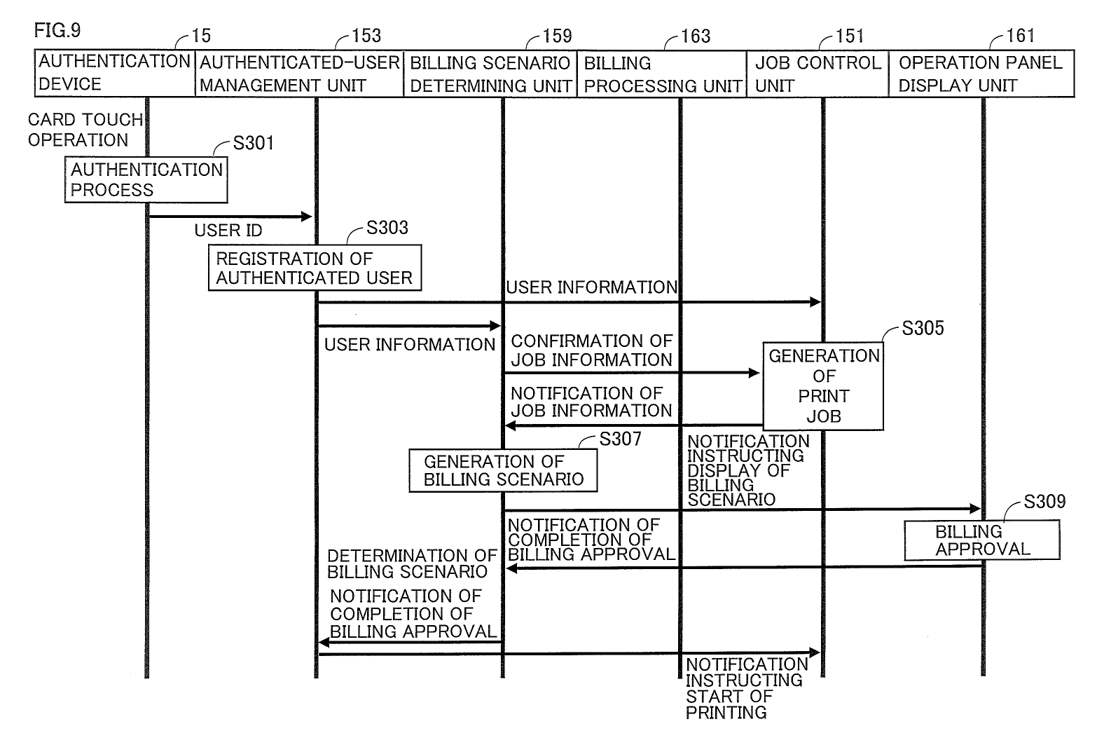

FIG. 8 is a flowchart illustrating a flow of the post-authentication printing operation.

The user who has transmitted a job to MFP 10 by the PC print job registration process performs card authentication in order to obtain permission to use MFP 10. The user uses the user's own card 90 to perform card authentication with authentication device 15, so as to cause MFP 10 to authenticate the user's account.

In step S201, the user performs an operation of bringing the user's own card 90 close to authentication device 15 (which may be called a “card touch operation”). In response to the card touch operation, authentication device 15 (or the CPU included in authentication device 15; the same applies hereinafter) reads information from the card 90 brought close to authentication device 15. At this time, the user ID and other user attribute information and the card ID, which are stored in card 90, are read by authentication device 15. Authentication device 15 also reads the authenticated-user management table from MFP 10. Authentication device 15 then compares the pair of the user ID and the card ID read from card 90 with the pair of the user ID and the card ID included in the authenticated-user management table, to perform authentication of card 90, or, the user corresponding to that card 90.

In step S203, authentication device 15 transmits to MFP 10 the authentication result and the user ID corresponding to the authenticated card 90. When authenticated-user management unit 153 in MFP 10 (or CPU 101 in MFP 10; the same applies hereinafter) receives the information transmitted from authentication device 15, it registers the corresponding user as an authenticated user, on the basis of the authentication result and the user ID as well as the authenticated-user management table (FIG. 7). Authenticated-user management unit 153 lifts the restrictions on the use of MFP 10 (or, gives permission to use MFP 10) for the user registered as the authenticated user. Authenticated-user management unit 153 lifts the use restrictions for example within the range based on the permission information recorded in correspondence with the user in the authenticated-user management table. As a result, the user who has been successfully authenticated by the card authentication is able to use MFP 10 and access (open) the BOX assigned to that user.

The use permission may include the permission to form images in full color, and the permission to execute a watermark printing function, as will be described later. The user attribute information may include the information about the use permission for each user. In this case, authenticated-user management unit 153 may lift the restrictions on the use of MFP 10 for the authenticated user, on the basis of the permission information included in the user attribute information corresponding to that authenticated user.

In step S205, job control unit 151 performs a process of retrieving data such as a document stored in the BOX associated with the authenticated user. The process becomes executable when authenticated-user management unit 153 lifts the restriction on the user's access to the BOX. Specifically, the operations of job control unit 151 are executed, e.g., by CPU 101, RAM 121, HDD 130, and others.

If the data such as a document is stored in the BOX associated with the authenticated user, in step S207, job control unit 151 generates and registers a print job for the data. This process is performed collectively for the data detected in the retrieval process. That is, in the case where data for a plurality of jobs are stored in the BOX corresponding to the authenticated user by the PC print job registration process, a (print) job for all the plurality of jobs is generated and registered. Alternatively, job control unit 151 may generate a job for one or more jobs satisfying a predetermined condition among the plurality of jobs. The job generated by job control unit 151 is for printing one document or two or more documents.

When job control unit 151 generates a job, job control unit 151 executes the job in step S209. The job is executed in a manner similar to the case of a typical printing job in which a job is transmitted from PC 3 or the like and printed. That is, for execution of the job, printing control unit 167 reads the data from within image storage unit 165, and controls printing unit 124 on the basis of the read data, to thereby perform a printing operation for forming an image according to the data. The operations of printing control unit 167 are executed, e.g., by CPU 101, RAM 121, and others.

When the printing operation is performed in step S209, a process of billing users is performed in step S211. In the billing process, a billing operation, which is performed along with the authentication printing function as will be described later, is performed for the printing operation that has been finished. The billing operation will be described later in detail. When the printing operation and the billing operation are completed, the post-authentication printing operation is terminated, whereby the authentication printing function is completed. With the authentication printing function, it is possible to readily perform printing, while guaranteeing a high level of security.

### (5) Billing Operation

### (5a) Flow of the Billing Operation

When MFP 10 executes the authentication printing function as described above, MFP 10 performs an operation of billing a predetermined user for the performed operation. The billing operation will now be described. The billing operation is performed primarily by authentication device 15, job control unit 151, authenticated-user management unit 153, billing scenario determining unit 159, operation panel display unit 161, and billing processing unit 163. That is, authentication device 15 and these units in MFP 10 constitute an example of the billing device, which implements the billing function. Specifically, the billing operation is performed by the operations of CPU 101, RAM 121, display and operation unit 125, and HDD 130 in MFP 10, and authentication device 15.

In the present embodiment, card 90 stores account information for a user corresponding to that card 90. The account information includes, among others, information about the balance of account related to billing. When the user, or card 90, is billed, the charge is subtracted from the balance, on the basis of the account information of that card 90. In this manner, each user may be billed for the charge. The account information does not necessarily have to be stored in card 90. For example, a table including the account information for the users who have been registered to be accessible to MFP 10 may be stored in HDD 130 in MFP 10, authentication device 15, or an external server. In this case, when card authentication is performed, CPU 101 or the like may read from the account information table the account information of the user corresponding to the authenticated card 90, so as to bill the user for the charge.

Firstly, the flow of the billing operation will be roughly described. The billing operation is carried out in parallel with the authentication printing function when a card touch operation is performed for card authentication.

FIG. 9 illustrates the operations of MFP 10 and authentication device 15 related to billing, which are performed before the printing job is started.

When a user performs a card touch operation on authentication device 15, authentication device 15 performs card authentication in step S301. Authentication device 15 notifies authenticated-user management unit 153 of the information about the authenticated card and the user ID information (authenticated-user information) corresponding to that card. Here, in the case where the simultaneous authentication as described above is accomplished, authentication device 15 notifies authenticated-user management unit 153 of the user ID information and others for each of the plurality of authenticated cards 90.

In step S303, for each of the user IDs notified from authentication device 15, authenticated-user management unit 153 performs a search process to determine whether the user ID matches any of the user IDs included in the records in the authenticated-user management table. For the user ID for which the match has been found as a result of the search process, authenticated-user management unit 153 registers the corresponding user as an authenticated user. If the matches have been found for two or more user IDs, a plurality of authenticated users are registered correspondingly. Authenticated-user management unit 153 notifies job control unit 151 and billing scenario determining unit 159 of the information about the registered authenticated user.

In response to registration of the authenticated user in authenticated-user management unit 153, in step S305, job control unit 151 performs a retrieval process of retrieving a document from within the BOX for the authenticated user. If there is any document retrieved in the retrieval process, job control unit 151 generates and registers a job related to that document. Job control unit 151 controls such that the job printing operation is stopped, so that the job is not executed at this time.

Further, in response to registration of the authenticated user in authenticated-user management unit 153, in step S307, billing scenario determining unit 159 confirms information about the job generated by job control unit 151 (which may also be referred to as “printing job information”). Job control unit 151 notifies billing scenario determining unit 159 of the information about the generated job. Upon receipt of the notification from job control unit 151, billing scenario determining unit 159 performs a billing scenario generating process. The billing scenario generating process is performed prior to execution of the generated job. In the present embodiment, the content of determination as to which user will be billed in what manner is called the “billing scenario”. For example, the billing scenario includes: account information about the accounts to be billed according to the scenario; billing information indicating the charge (price) and the like; and billing condition information indicating the time of billing and the like. The billing scenario generating process and the billing scenario will be described later in detail.

In step S309, billing scenario determining unit 159 performs a billing scenario confirmation process to obtain approval from the user. Specifically, billing scenario determining unit 159 displays a determined billing scenario on operation panel display unit 161 and waits for the user to perform an approval operation. Operation panel display unit 161 displays the billing scenario in the form of a billing scenario confirmation screen, which will be described later in detail.

The billing scenario confirmation screen displayed on operation panel display unit 161 allows the user to confirm the job for which the charge is to be billed, the users who are to be billed, the amount to be billed, and others. When the user sees no problem about the contents of the billing scenario being displayed, the user inputs an approval operation to operation panel display unit 161 (“billing approval”). On the other hand, if the contents of the billing scenario being displayed are not as desired by the user, the user may perform a predetermined operation, as will be described later, to change the settings of the billing scenario. Alternatively, the user may perform another predetermined operation to discard the job so that the job is not executed.

When the user performs the approval operation for the billing scenario, operation panel display unit 161 notifies billing scenario determining unit 159 that the billing scenario has been approved, i.e., the billing approval has been completed. Upon receipt of that notification, billing scenario determining unit 159 notifies authenticated-user management unit 153 to that effect. When authenticated-user management unit 153 receives the notification of completion of billing approval from billing scenario determining unit 159, authenticated-user management unit 153 issues a notification instructing start of printing to job control unit 151.

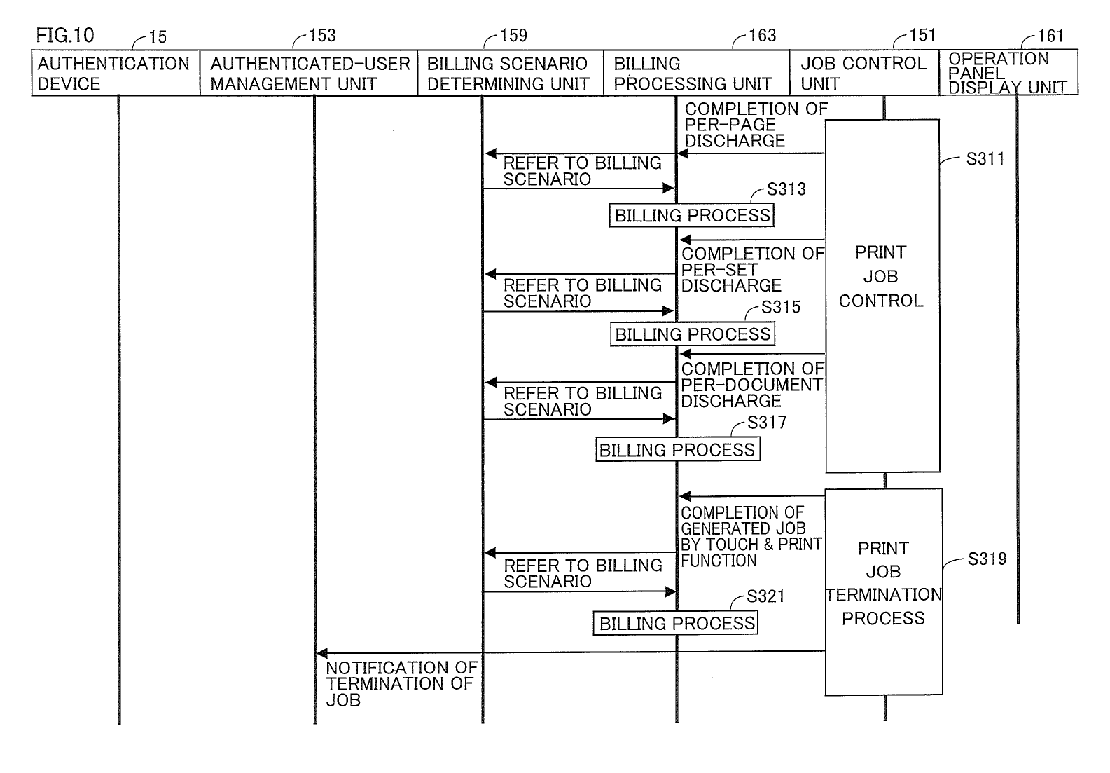

FIG. 10 illustrates the operations of MFP 10 related to billing, which are performed after the printing job has been started.

When job control unit 151 receives the notification instructing start of printing from authenticated-user management unit 153, in step S311, job control unit 151 executes the job that has been generated in step S305 and held in a waiting state, to start printing. While executing the job, every time a predetermined event takes place, job control unit 151 issues a notification to that effect (which is referred to as an “event notification”) to billing processing unit 163.

The predetermined event may include the following events which take place during the job control. An event of “completion of printing per page (completion of per-page discharge)” takes place every time a sheet of paper is printed and discharged from MFP 10. In the case where a certain document is to be printed in units of sets, an event of “completion of printing per set (completion of per-set discharge)” takes place every time a set of printouts is discharged from MFP 10. In the case where the job is for a plurality of documents, an event of “completion of printing per document (completion of per-document discharge)” takes place every time the printing operation is completed for one of the documents.

In each of steps S313 to S317, billing processing unit 163 performs a billing process in accordance with the billing scenario approved by the user. That is, every time the event notification is received from job control unit 151, billing processing unit 163 refers to the billing scenario which has been approved and determined by billing scenario determining unit 159. If the event is the one for which a charge is to be levied, billing processing unit 163 performs billing for that event, in accordance with the billing scenario.

In step S319, job control unit 151 performs a print job termination process. When the generated job is executed by the authentication printing function (touch-and-print function) and the printing is all completed, job control unit 151 issues a notification to that effect (“notification of completion of job”) to billing processing unit 163.

Upon receipt of the notification of completion of job, in step S321, billing processing unit 163 refers to the billing scenario in billing scenario determining unit 159. In the case where the event of “completion of generated job by touch and print function” at that time is the one for which a charge is to be levied, billing processing unit 163 performs a billing process. At this time point, billing processing unit 163 performs a predetermined billing process that should be performed upon completion of the job, such as the billing for the use of a special function (which may be referred to as an “application (or, an application program)”), as will be described later.

After the billing process is performed in step S321, job control unit 151 issues a notification of termination of job to authenticated-user management unit 153. Upon receipt of the notification of termination of job, authenticated-user management unit 153 terminates a series of processes for the registered authenticated user.

### (5b) Billing Scenario Generating Process

Now, the billing scenario generating process (S307 in FIG. 9) performed by billing scenario determining unit 159 will be described. Billing scenario determining unit 159 performs the billing scenario generating process to generate a billing scenario. Billing scenario determining unit 159 performs the billing scenario generating process on the basis of the billing patterns which are set in advance, the authenticated-user information about the authenticated users who are to be billed, the information about the job to be printed (“printing job information”), and the like.

FIG. 11 is a flowchart illustrating the operations of MFP 10 in the billing scenario generating process.

In step S01, billing scenario determining unit 159 selects and determines a billing pattern to be used for generating a billing scenario, from among the billing patterns set in advance. At this time, billing scenario determining unit 159 refers to the authenticated-user management table (FIG. 7), for example, to select the billing pattern that corresponds to the authenticated-user information, the information about the owner of the job to be executed (i.e., the user who has executed the PC print job registration process), or the like. The billing patterns possessed by billing scenario determining unit 159 will be described later in detail. Specifically, the operations of billing scenario determining unit 159 are executed, e.g., by CPU 101, RAM 121, HDD 130, and others.

In step S02, billing scenario determining unit 159 acquires (collects) the information about the job generated by job control unit 151 (“printing job information”). The printing job information includes information about the sheets of paper to be used, the number of copies to be printed, color type, whether to use an application or not, the application to be used, and others.

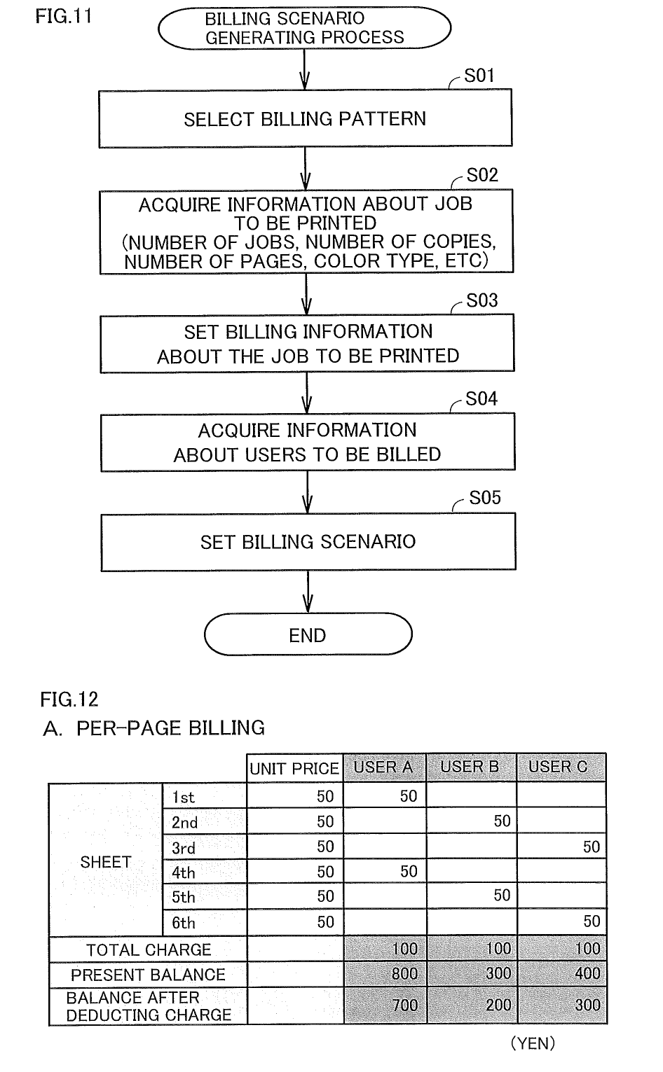

In step S03, billing scenario determining unit 159 sets billing information for the job to be printed, on the basis of the collected printing job information as well as the selected billing pattern. Specifically, billing scenario determining unit 159 performs classification of events for each of which a charge will be billed in accordance with the selected billing pattern, on the basis of the number of pages in a document included in the job, the designated number of copies to be printed, the number of documents included in the job, and the like. In other words, billing scenario determining unit 159 determines the events for which the charges will be levied upon execution of the job, and the charge (price) to be billed for each event. In this manner, the information corresponding to the vertical axis in a billing scenario table, which will be described later, is set. For example, billing scenario determining unit 159 generates the information corresponding to the rows and columns of “sheet: 1st through 6th” and “unit price: 50 yen” in the form of a table as shown in FIG. 12, which will be described later. Billing scenario determining unit 159 refers to printing and application unit price table 157 to determine the charge for each event.

In step S04, billing scenario determining unit 159 collects the information about the users who will be billed for the job to be printed, from the information notified from authenticated-user management unit 153. Billing scenario determining unit 159 sets the users who will be billed as “targets to be billed” in the billing scenario table. For example, billing scenario determining unit 159 sets all the authenticated users as the targets to be billed. In this manner, the information corresponding to the horizontal axis in the billing scenario table is set. Specifically, billing scenario determining unit 159 generates the information corresponding to the columns of “user A”, “user B”, and “user C” in the form of a table as shown in FIG. 12, which will be described later. As the targets to be billed, billing scenario determining unit 159 may select only those satisfying a predetermined condition from among the authenticated users.

In step S05, billing scenario determining unit 159 performs a billing scenario setting process. That is, in the billing scenario table generated in steps S03 and S04, billing scenario determining unit 159 allocates a charge among the users on an event basis, in accordance with the selected billing pattern. For example, assume that a per-page billing pattern as shown in FIG. 12 (which will be described later) has been selected and that three users A, B, and C have been set as the targets to be billed. In this case, billing scenario determining unit 159 allocates the charge of 50 yen for the first page to user A, the charge for the second page to user B, and the charge for the third page to user C. After making the circuit of three users A, B, and C, billing scenario determining unit 159 allocates the fourth and subsequent pages to users A, B, and C, in turn, to thereby allocate the charge on a page basis. Billing scenario determining unit 159 terminates the process at the time point when it has completed allocation of the entire charge. Billing scenario determining unit 159 determines a billing scenario on the basis of the data of the generated billing scenario table. Billing scenario determining unit 159 may allocate 0 (zero) yen to any of the users as the targets to be billed, so that the user is billed for substantially no charge.

### (5c) Billing Pattern

Examples of the billing patterns set in advance in billing scenario determining unit 159 will now be described.

For example, seven types of billing patterns A to G as shown in FIGS. 12 to 18, respectively, are set in billing scenario determining unit 159. When any of the billing patterns is selected in step S01 in the billing scenario generating process, a billing scenario is generated in billing scenario determining unit 159 on the basis of the selected billing pattern. In the following, each billing pattern is shown in the form of a billing scenario which is generated based thereon.

FIG. 12 shows a billing pattern A.

The billing pattern A is selected in the case of billing a charge on a per-page basis (“per-page billing”). That is, according to the billing pattern A, irrespective of the number of copies or the number of documents, the users as the targets to be billed are sequentially billed every time one page is printed (“first billing process” which will be described later). In this manner, a total charge levied according to the execution of the job is approximately equally allocated among the users as the targets to be billed.

For example, assume that a total of six pages are printed out for three users A, B, and C by execution of a job, with the unit price per page (charge) being 50 yen. In this case, as shown in FIG. 12, the charge for the first page is allocated to user A, the charge for the second page is allocated to user B, and the charge for the third page is allocated to user C. Similarly, the charges for the fourth, fifth, and sixth pages are allocated to users A, B, and C, respectively. That is, users A, B, and C are each billed for 100 yen in all. In the case where the billing pattern A is selected, 50 yen is charged every time one page is printed. FIG. 12 shows, for each of users A, B, and C, the present balance (which is the balance of account before start of the job) and the balance after deducting the charge (which is the balance of account after completion of the job).

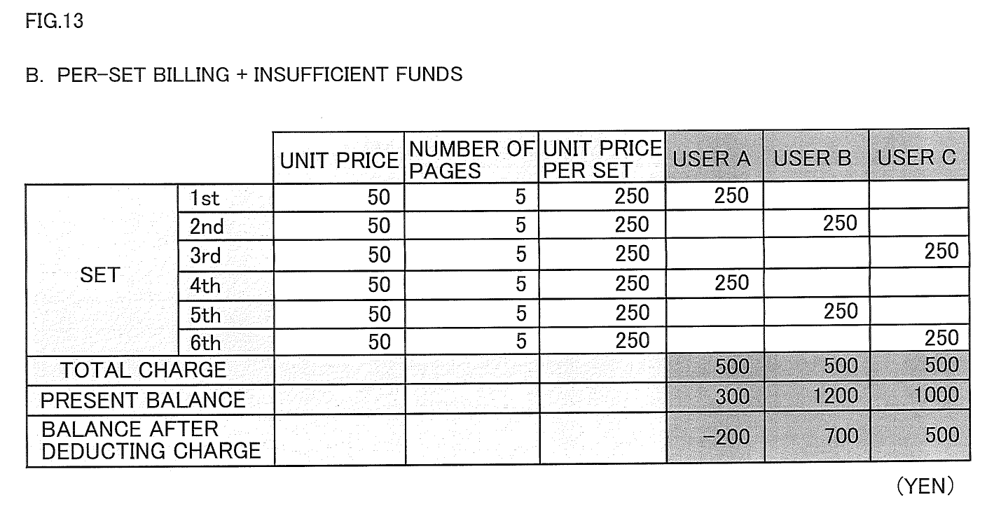

FIG. 13 shows a billing pattern B.

The billing pattern B is selected in the case of billing a charge on a per-set basis (“per-set billing”). According to the billing pattern B, the users as the targets to be billed are sequentially billed every time one set of copies is printed out for one document (“second billing process” which will be described later). In this manner, a total charge levied according to the execution of the job is approximately equally allocated among the users as the targets to be billed.

For example, assume that six sets of copies of a document having five pages are output for three users A, B, and C, by execution of a job, with the unit price per page (charge) being 50 yen and the unit price per set being 250 yen. The charge for each set is allocated sequentially to users A, B, and C. That is, the charges for the first set and the fourth set are allocated to user A, the charges for the second set and the fifth set are allocated to user B, and the charges for the third set and the sixth set are allocated to user C. As a result, users A, B, and C are each billed for 500 yen in all. In the case where the billing pattern B is selected, 250 yen is charged every time an event notification indicating that printing of one set has been completed is issued.

While the billing scenario shown in FIG. 13 is for one document, in the case of printing two or more sets of two or more documents as well, the billing scenario is generated in such a manner that the user to be charged is changed sequentially for each set of copies.

In the example shown in FIG. 13, the balance after deducting the charge for user A takes a negative value. This means that, if the billing operation is performed in accordance with this billing scenario, the funds in the user A's account will be insufficient. In such a case that there is an account of which balance will become insufficient, billing scenario determining unit 159 performs an insufficient-funds handling process, which will be described later in detail.

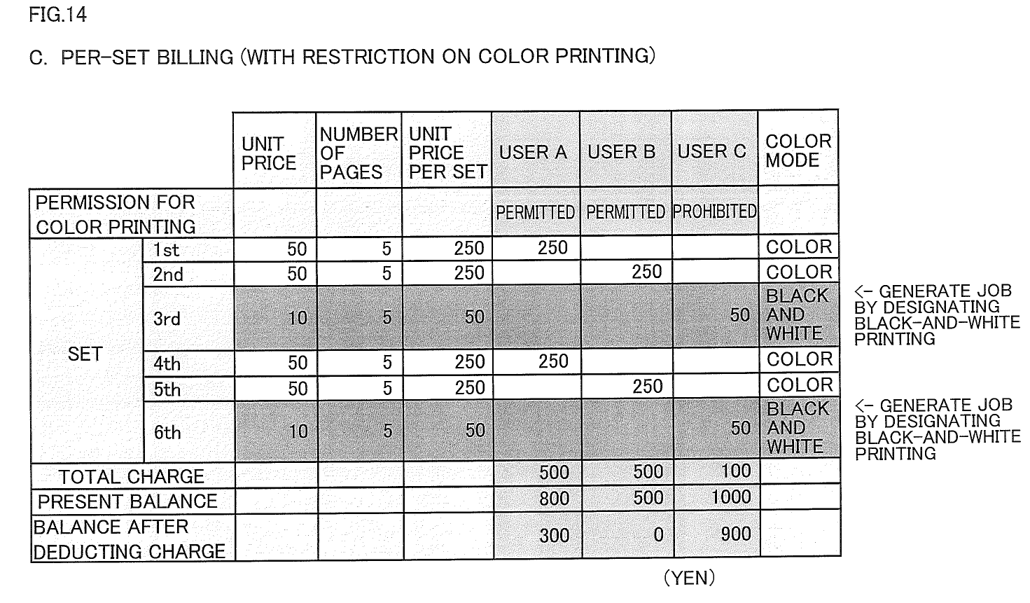

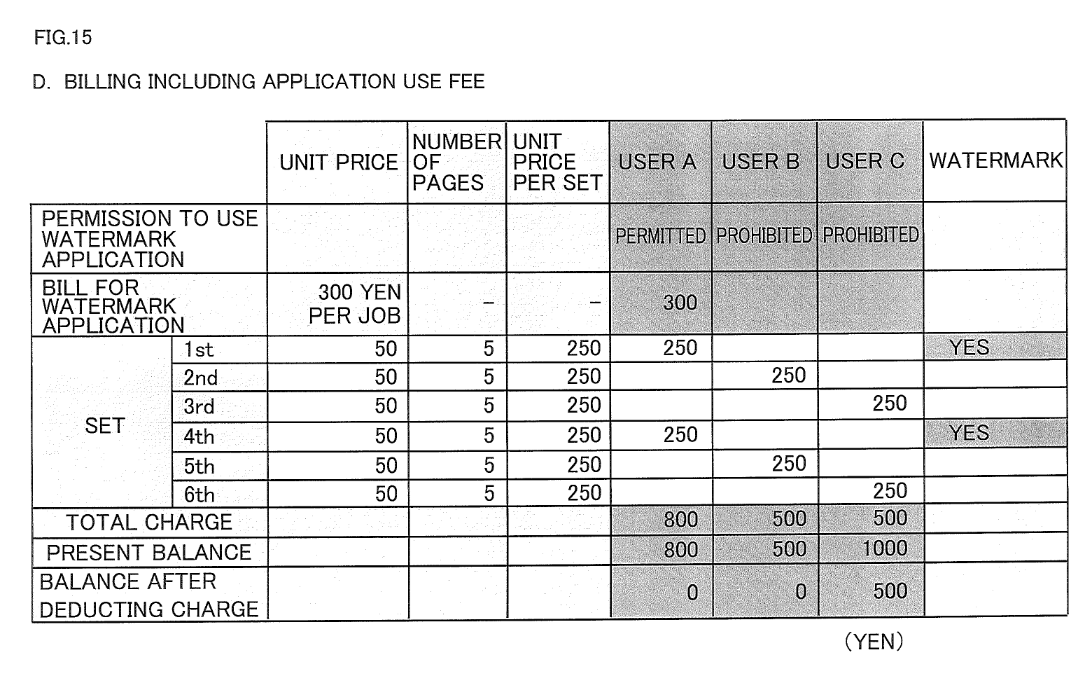

FIG. 14 shows a billing pattern C.

The billing pattern C is selected for performing the “per-set billing” in the state where a restriction on the use of a function that levies a charge is placed on one or more of the users. According to the billing pattern C, as in the billing pattern B, the users as the targets to be billed are sequentially billed every time one set of copies is printed out for one document (“second billing process” which will be described later). In the billing pattern C, the users are billed for different amounts in accordance with the presence/absence of, and the content of, the use restriction.

For example, assume that six sets of copies of a document having five pages are output for three users A, B, and C, by execution of a job. Here, the color printing is permitted for users A and B, while it is prohibited for user C. For the color printing, the unit price per page (charge) is 50 yen and the unit price per set is 250 yen, while for the black-and-white printing, the unit price per page (charge) is 10 yen and the unit price per set is 50 yen.

In the billing pattern C, the charge for each set is allocated sequentially to users A, B, and C. As to users A and B, the color printing is performed, and thus, users A and B are each billed for 250 yen per set. As to user C for whom the color printing is prohibited, the black-and-white printing is performed, and thus, user C is billed for 50 yen per set. That is, in this case, the difference in function between the color printing and the black-and-white printing results in the difference between the charge billed to users A, B and the charge billed to user C. Such a difference in unit price is set by billing scenario determining unit 159 in accordance with the presence/absence of the use limit for each of users A, B, and C, and by referring to printing and application unit price table 157. In the case where the billing pattern C is selected, the billing process is performed every time an event notification indicating that printing of one set has been completed is issued.

As described above, in the case where different printing modes or different output functions are set for the respective users, a charge is allocated among the users in accordance with the differences. This ensures that the charge is fairly allocated among the users. The charge is determined in accordance with the difference in output function. This ensures more fair and impartial allocation of the charge.

When the billing scenario as shown in FIG. 14 is generated, job control unit 151 may refer to the billing scenario to switch the print control between the color mode and the black-and-white mode during the execution of the job. That is, the billing scenario may be utilized as the print mode setting information. This allows various kinds of setting data to be organized in MFP 10, which leads to simplified processing.

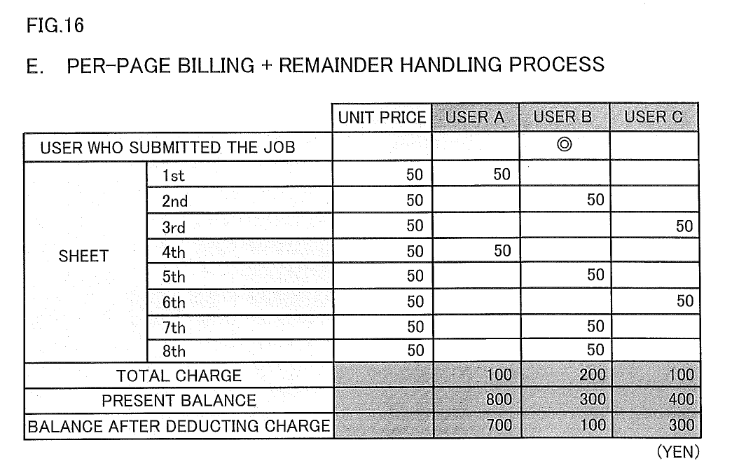

FIG. 15 shows a billing pattern D.

The billing pattern D is selected for performing the “per-set billing” in the case where an additional function (special function) is used for printing in addition to the basic printing function. According to the billing pattern D, as in the billing pattern B, the users as the targets to be billed are sequentially billed every time one set of copies is printed out for one document (“second billing process” which will be described later). In the billing pattern D, any user who uses the additional function is billed for an extra charge.

An example of such additional functions is a function to generate a pattern of watermark on the background of the sheet of paper (which may be referred to as a “watermark application”). When the watermark application is used for printing a watermark, the characters appear when the printout is copied, so that it can substantially prohibit duplication of the print. Further, generation of a watermark specific to a certain print enables tracking of the printed matter. Such an additional function requires extra cost, and thus, the use limit may be set for each user.

For example, assume that six sets of copies of a document having five pages are output for three users A, B, and C, by execution of a job. Here, the use of the additional function (watermark application) is permitted only to user A, which is not permitted to the other users B and C. The unit price per page (charge) is 50 yen and the unit price per set is 250 yen. For the use of the watermark application, 300 yen is billed, e.g., every time it is used for one job. In this case, users A, B, and C are sequentially billed for 250 yen for each set. For this charge, the billing process is performed every time one set of copies is printed out (“second billing process” which will be described later). Here, as to user A, printing is performed using the watermark application (for the first and fourth sets). Thus, user A is additionally billed for 300 yen when execution of the job is completed, i.e., when six sets of copies are all printed out. As a result, user A is billed for 800 yen in all, while the other users B and C are each billed for 500 yen in all.

As described above, in the case where only some of the users are allowed to use an additional function, a charge is allocated among the users correspondingly. This ensures that the charge is fairly allocated among the users. Further, even if a user who is allowed to use an additional function and a user who is not allowed to use the same are to perform a single job, the use of the additional function may be permitted and the billing process can be performed for the charge levied according to the additional function. Still further, even in the case where the billing manner, including the time of billing and the unit price, varies depending on the use of the additional function or on the event, a predetermined charge may be billed in accordance with each billing manner. Accordingly, it is possible to generate a billing scenario in accordance with the actual use conditions, to bill for a charge in an appropriate manner.

When the billing scenario as shown in FIG. 15 is generated, job control unit 151 may refer to the billing scenario to switch the use/non-use of the additional function during the execution of the job. That is, the billing scenario may be utilized as the print mode setting information. This enables organization of various kinds of setting data in MFP 10 and, hence, simplification of the processing.

FIG. 16 shows a billing pattern E.

The billing pattern E is selected for example for performing the “per-page billing” in the case where a total number of pages to be printed in a job cannot be distributed evenly among the users as the targets to be billed. That is, the billing pattern E is selected when the total number of pages cannot be divided by the number of users, and is configured to bill a particular user for the charge for the remaining pages or the remainder (corresponding to the remainder when the total number of pages is divided by the number of users). According to the billing pattern E, as in the billing pattern A, the users as the targets to be billed are sequentially billed every time one page is printed out (“first billing process” which will be described later). At this time, there may be outstanding pages, i.e., the total number of pages may not be divided by the number of users, depending on the relationship between the total number of pages to be printed and the number of users to be billed. In the billing pattern E, the user who has executed the authentication printing function, for example, is billed for the charge for the remainder.

For example, assume that eight pages are printed out for three users A, B, and C by execution of a job, with the unit price per page (charge) being 50 yen, and that user B is the owner of the job who has submitted or transmitted the job from PC 3 or the like to MFP 10. At this time, the charge of 50 yen for each page is allocated sequentially to users A, B, and C in this order, and thus, each user A, B, C is billed twice up to the sixth page. The remaining two pages of seventh and eighth pages, however, are outstanding. In this case, user B who has submitted the job is billed collectively for the seventh and eighth pages. As a result, users A, B, and C are billed for 100 yen, 200 yen, and 100 yen, respectively. In the case where the billing pattern E is selected, the billing process is performed, for 50 yen, every time one page is printed out.

The user to be billed for the remainder is specified in this manner, which can support various kinds of billing manners.

The user who is to be billed for the remainder does not necessarily have to be the user who has submitted the job. For example, in the case of the first simultaneous authentication described above, the user corresponding to card 90 that is the farthest from authentication device 15 (i.e., the card stacked at the top), or the user corresponding to card 90 that is the closest to authentication device 15 (i.e., the card stacked at the bottom) may be billed for the remainder. In the case of the second simultaneous authentication described above, the user corresponding to card 90 that has been read firstly or lastly may be billed for the remainder. Moreover, not limited to a single user, a predetermined number of users may be billed for the remainder. In this case, in the case of the first simultaneous authentication, the charge for the remainder may be allocated among the users corresponding to a predetermined number of cards 90 from the one farthest from authentication device 15 (i.e., the predetermined number of cards from the top of the stack), or among the users corresponding to a predetermined number of cards 90 from the one closest to authentication device 15 (i.e., the predetermined number of cards from the bottom of the stack). In the case of the second simultaneous authentication, the charge for the remainder may be allocated among the users corresponding to a predetermined number of cards 90 from the one that was read firstly, or among the users corresponding to a predetermined number of cards 90 from the one that was read lastly.

In the above description, in the case where the total number of pages to be printed in a job cannot be evenly distributed among the users as the targets to be billed, one or more particular users are billed for the remainder. Similarly, in the case where the total number of sets of copies to be printed in a job cannot be evenly distributed among the users as the targets to be billed, one or more particular users may be billed for the remainder.

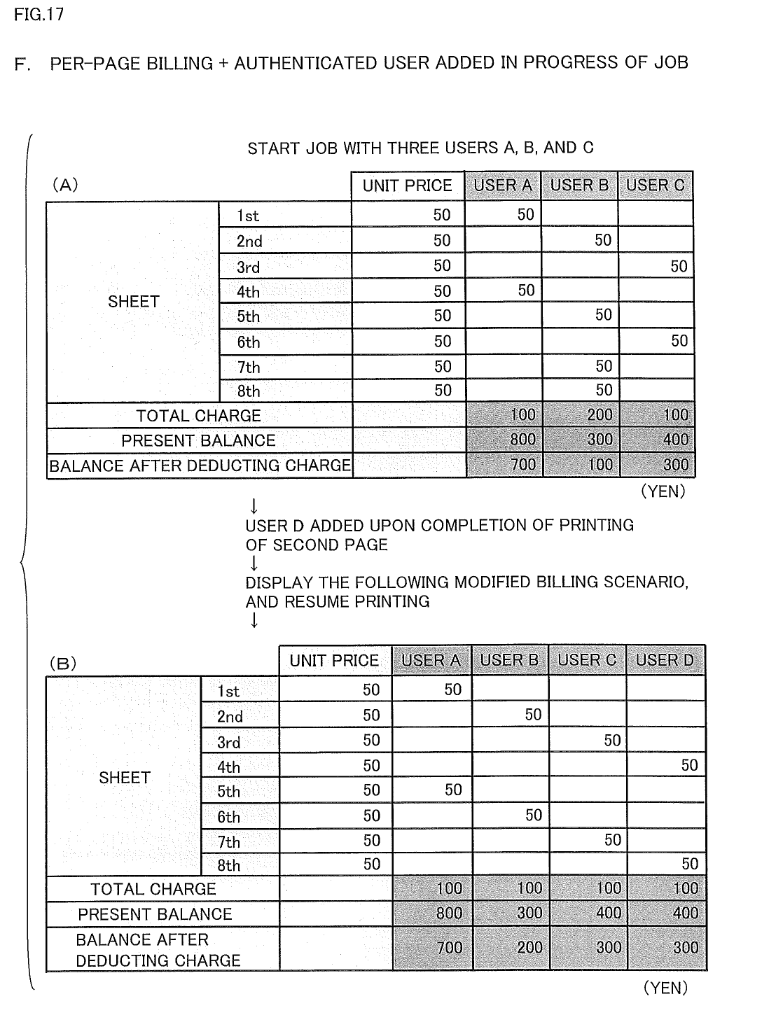

FIG. 17 shows a billing pattern F.

The billing pattern F is similar to the billing pattern A in that it is selected for example for performing the “per-page billing”. The billing pattern F, however, greatly differs from the billing pattern A in that, when card authentication is performed for an additional user within a predetermined period of time from when the simultaneous authentication was performed in the first place, the billing scenario is re-generated such that the additional user is billed as well. That is, in the case where the billing pattern F is selected, the billing scenario may be modified at the time when card authentication is performed for an additional user during the execution of the job. The number of users as the targets to be billed may be increased even while the job is being executed, to enable allocation of the charge to the relevant user as well. This increases the degree of freedom of use of MFP 10, whereby MFP 10 becomes more convenient to use. The predetermined period of time during which a user can be added may be set in various manners. For example, the period may be set to be a predetermined period from the time when the process of allocating a charge was started, i.e., from the start of execution of the billing scenario generating process to the end of execution of the job, and the like.

For example, assume that eight pages are to be printed out by execution of a job, with the unit price per page (charge) being 50 yen, and that three users A, B, and C have been authenticated prior to the start of the job, with user B being the owner of the job. At this time, if the owner of the job is billed for the remainder as in the above-described pattern E, the billing scenario becomes as shown in (A) in FIG. 17.

Here, assume that, while the job is being executed, a card touch operation is performed using card 90 of a user D at the time point when the second page has been printed out. At this time, user D is additionally registered as the authenticated user. When user D is additionally registered, billing scenario determining unit 159 performs the billing scenario generating process again, to generate a billing scenario for four users A, B, C, and D, as shown in (B) in FIG. 17. Billing scenario determining unit 159 displays the generated billing scenario on operation panel display unit 161 so as to obtain approval by the user. During this time, job control unit 151 stops the execution of the job. When the user performs the approval operation (billing approval), job control unit 151 resumes the printing job from the third page. Alternatively, it may be configured to perform the billing process in accordance with the newly generated billing scenario, without seeking the approval by the user.

According to the newly generated billing scenario, users A to D are sequentially billed for 50 yen every time one page is printed out (“first billing process” which will be described later). As a result, users A to D are each billed for 100 yen in all. In the case where the billing pattern F is selected, 50 yen is charged every time one page is printed.

In the case where the card authentication is additionally performed during the billing scenario generating process as well, the billing scenario may be re-generated so as to include the card (user), as in the above-described manner. This allows the user to perform the operation of adding another card (user) as the targets to be billed, as necessary, during the time when the billing approval process is in progress for example, by seeing the billing scenario confirmation screen. The card (user) can be added only with a simple, card touch operation.

Even when the billing pattern F is selected, if no user has performed card authentication while the printing operation is conducted based on the initially generated billing scenario, the billing is performed in accordance with the initially generated billing scenario. That is, in the above-described example, the billing is performed in a similar manner as in the example described above in conjunction with the billing pattern E (see the billing scenario shown in (A) in FIG. 17).

In the case where additional card authentication is performed when the job is nearly completed, the billing scenario may be re-generated including the relevant user, and the charge already billed may be reset, so that the billing process may be performed again from the beginning. Alternatively, after the additional card authentication is performed, the added user may be concentratedly billed for the charge until the total amount charged to that user becomes equal to the amount charged to each of the other users. Specifically, assume that users A, B, and C have been authenticated simultaneously to perform a job including eight pages and that user D has been additionally authenticated after six pages have been printed out. In this case, user D may be billed consecutively for the remaining seventh and eighth pages.

Still alternatively, it may be configured such that, even during the time when the job is being executed, addition of a user is not accepted in the case where the total amount billed to a respective one of the users cannot be balanced if another user is added. Specifically, assume that users A, B, and C have been authenticated simultaneously to perform a job including 90 pages, and that 87 pages have already been output and users A, B, and C have been billed for 29 pages each. In this case, it may be configured not to perform card authentication even if user D brings card 90 close to authentication device 15.

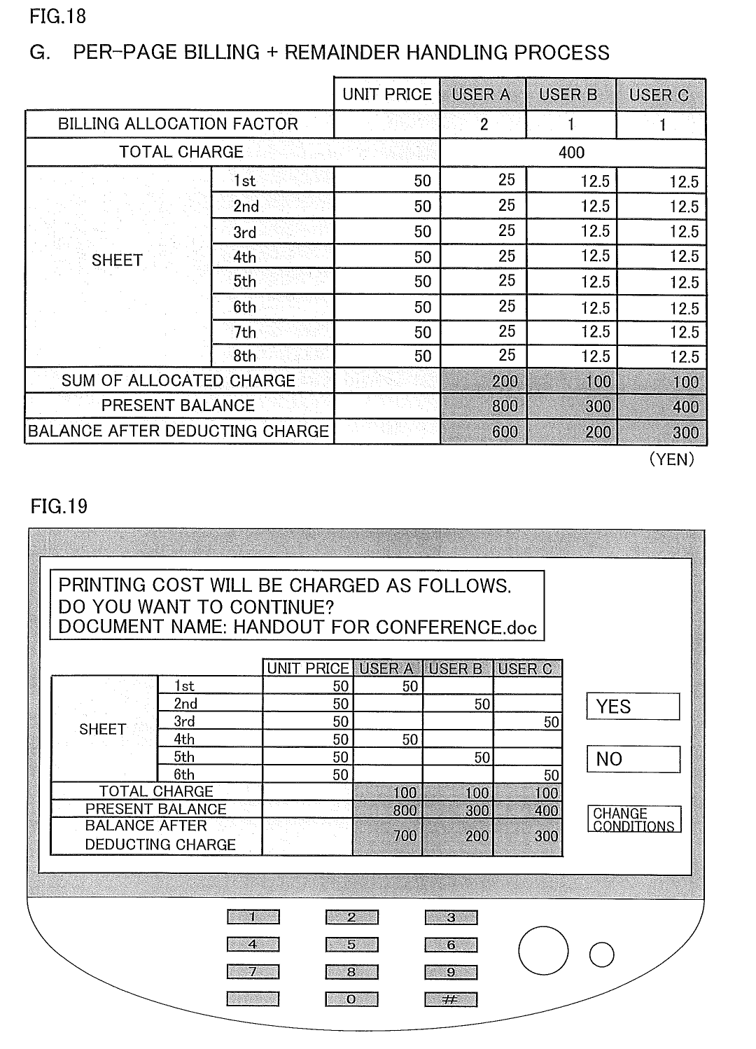

FIG. 18 shows a billing pattern G.

The billing pattern G is for billing a plurality of users for different amounts which are weighed by predetermined ratios. That is, according to the billing pattern G, a different amount is allocated to each user in accordance with a predetermined billing ratio (billing allocation factor) set for the user. The billing allocation factor is stored in advance in the authenticated-user management table, for example, in association with the user. The billing allocation factor may be stored in card 90 of each user as the user attribute information. The billing allocation factor may be changed as appropriate in accordance with a setting by a user. For example, the user may press a factor change key on a billing scenario confirmation screen, which will be described later.

For example, assume that eight pages are to be printed out by execution of a job, with the unit price per page (charge) being 50 yen, and that the job is executed for three authenticated users A, B, and C. Here, if the billing allocation factors for users A, B, and C are 2:1:1, then a charge is allocated among users A, B, and C in accordance with the ratios of 2:1:1. For example, the billing is performed every time one page is printed out, and a charge is distributed among the users for each page. In this case, user A is billed for 25 yen and users B and C are each billed for 12.5 yen every time one page is output (“first billing process” which will be described later). Accordingly, for the whole job, user A is billed for 200 yen in all, and users B and C are each billed for 100 yen in all. That is, the users are billed in accordance with the billing allocation factors.

According to the billing pattern G, even in the case where the total number of pages to be printed in a job cannot be evenly distributed among the users as the targets to be billed, i.e., even if there is the remainder, a charge can be allocated among the users in accordance with predetermined billing allocation factors. It may be configured such that the billing pattern G is automatically selected when there is the remainder. At this time, the billing allocation factors may be set automatically in such a manner that the user who owns the job, for example, is billed for a greater amount. The billing allocation factor for a certain user may be set to “0”, in which case no cost is charged to the user whose billing allocation factor is “0” (in other words, 0 yen is allocated to the user).

It is noted that the billing patterns are not limited to the above-described billing patterns A to G; other billing patterns may be set as well. Further, in the billing patterns, the “per-page billing”, “per-set billing”, and “per-document billing” may be changed to one another as appropriate, or they may be combined for billing. For example, in the billing pattern F, the “per-page billing” may be replaced with the “per-set billing”. Furthermore, the billing manner in which a particular user is billed for the remainder of the charge and the billing manner in which a charge is billed in accordance with the use limit, for example, may be combined as appropriate for billing.

### (5d) Billing Scenario Confirmation Screen

FIG. 19 shows display and operation unit 125 on which a billing scenario confirmation screen is displayed.

As described above, during the billing approval process, billing scenario determining unit 159 displays a billing scenario on operation panel display unit 161 to obtain approval of the user (S309 in FIG. 9). To this end, the billing scenario confirmation screen as shown in FIG. 19 is displayed on display and operation unit 125.

The billing scenario confirmation screen includes a display regarding a billing scenario that is to be applied to the job to be executed, and a display for checking whether the user approves execution of the job in accordance with the billing scenario. The billing scenario confirmation screen includes a “yes” button, a “no” button, and a “change conditions” button, which may be pressed by the user.

The display regarding the billing scenario shows how much amount is billed for which object for each user, in an easily understandable table form as shown in FIG. 19. It also shows, for each user, a total charge, the balance of account before the charge is deducted (“present balance”), and the balance of account after the charge is deducted (“balance after deducting charge”). Such a display allows the user to surely recognize in advance the amount to be charged when the job is executed, and the job is performed only when the user approves the billing scenario. The billing is performed as intended by the user, which ensures greater user satisfaction.

The “yes” button corresponds to acknowledgment by the user (billing approval). When the “yes” button is pressed, the billing scenario is determined by billing scenario determining unit 159, and the job is executed by job control unit 151. The “no” button corresponds to denial by the user. When the “no” button is pressed, the process of discarding the job is performed by job control unit 151 under the control of CPU 101, and the printing is stopped. The “change conditions” button is for requesting changes to the billing scenario being displayed. When the “change conditions” button is pressed, billing scenario determining unit 159 performs a process of modifying the billing scenario. Specifically, the billing scenario generating process is carried out again, in which a billing pattern different from the one selected previously is selected and a billing scenario is re-generated on the basis of the selected billing pattern. Once the billing scenario is modified, or re-generated, billing scenario determining unit 159 displays the modified billing scenario on the billing scenario confirmation screen. Billing scenario determining unit 159 then accepts an operation of the user in the above-described manner.

The billing approval process may be performed by displaying the billing scenario confirmation screen on a monitor (display) provided in another external device connected to MFP 10, or on a display of PC (external device) 3a or 3b. The billing scenario confirmation screen may include, as the information related to the billing scenario, at least one of the account information, the balance information, and the billing conditions information.

### (5e) Billing Process

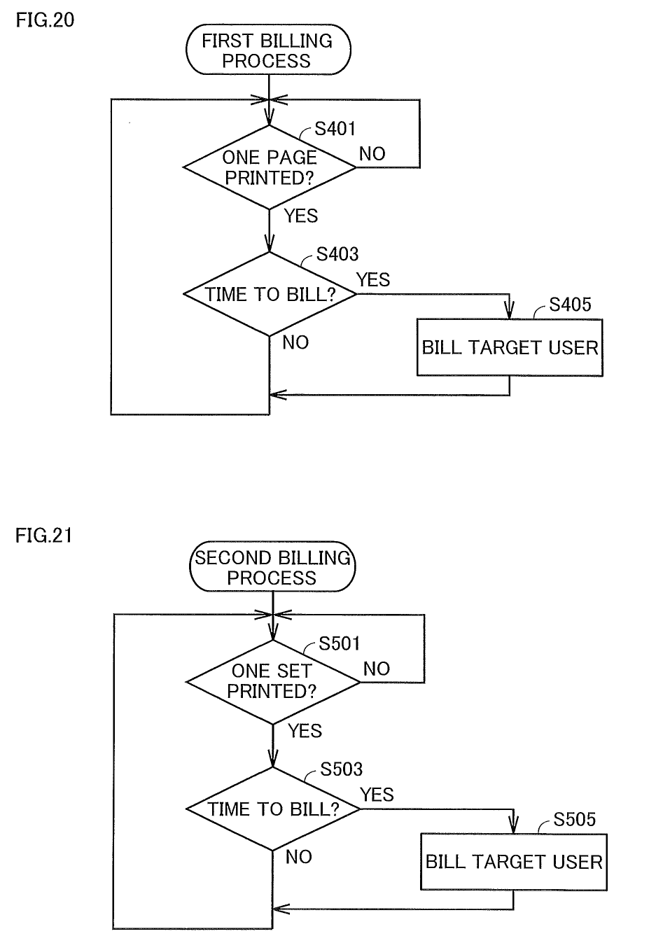

FIG. 20 is a flowchart illustrating an example of the billing process (“first billing process”).

The first billing process corresponds to the “per-page billing” described above. In the present embodiment, the first billing process is performed by billing processing unit 163 (or CPU 101; the same applies hereinafter) when a job is being executed, in the following manner.

In step S401, billing processing unit 163 waits until it receives from job control unit 151 an event notification (of “completion of printing per page”) indicating that one page has been printed out.

If the event notification is received in step S401, in step S403, billing processing unit 163 refers to the billing scenario to determine whether to perform billing at this time point.

If it is determined in step S403 that it is the time to bill, in step S405, billing processing unit 163 bills a user who is to be billed in accordance with the billing scenario, for a charge which is predetermined in the billing scenario.

When the billing is performed in step S405, or if it is determined in step S403 that it is not the time to bill, billing processing unit 163 waits until it receives a next event notification.

FIG. 21 is a flowchart illustrating another example of the billing process (“second billing process”).

In the present embodiment, the second billing process, which is the “per-set billing” described above, is carried out by billing processing unit 163 while a job is being executed, in the following manner.

In step S501, billing processing unit 163 waits until it receives from job control unit 151 an event notification (of “completion of printing per set”) indicating that one set of copies has been printed out.

Steps S503 and S505 are similar to steps S403 and S405 described above. That is, if the event notification is received, billing processing unit 163 determines whether to perform billing at this time point, in accordance with the billing scenario (S503). If it is the time to bill, billing processing unit 163 bills a target user for a predetermined amount, in accordance with the billing scenario (S505). When the billing is performed, or if it is not the time to bill, billing processing unit 163 waits for a next event notification.

The time when printing of one set of copies is completed is the time when printing of the last page in the set is completed. Thus, job control unit 151 issues two event notifications: one indicating that one page has been printed, the other indicating that one set of copies has been printed. In the case where the billing scenario requires that the billing be performed at either timing, billing processing unit 163 performs the first billing process or the second billing process in accordance with the billing scenario.

As described above, in the present embodiment, an event notification is issued when the event of a predetermined event type is finished, and billing processing unit 163 performs a billing process in each case. Therefore, if a predetermined event has not been finished, due to paper jam or the like, the billing process is not performed for the page or set that is being printed, or for any page or set yet to be printed. This prevents the billing process from being performed for the page/set that has not been printed yet in the event that the printing process is interrupted unexpectedly. In other words, the billing is performed reliably only after the printing is finished. After the printing is interrupted unexpectedly, when the printing is resumed from the page/set that was being printed, the billing is performed reliably from that page/set where printing has been resumed.

While the per-page billing and the per-set billing have been described above, per-document billing may be performed in a similar manner. That is, in the case where a print job includes a plurality of documents, every time printing of one of the documents is finished, job control unit 151 issues an event notification to that effect. In response to the event notification, billing processing unit 163 performs the billing process if it is the time to do so, in accordance with the billing scenario.

Instead of billing per page or per set, a whole charge may be billed after the entire job is finished by the authentication printing function. Performing the billing, at one time, for the total charge allocated among the users advantageously reduces the amount of processing performed by CPU 101 and others.

### (5f) Operations for Handling Insufficient Funds

In the present embodiment, billing scenario determining unit 159 carries out an insufficient-funds handling process. The insufficient-funds handling process is performed when it is detected that there is a card (user) of which balance will become insufficient (or, the funds in that user's account will be insufficient) if the charge is billed in accordance with the billing scenario generated by the billing scenario generating process. According to the insufficient-funds handling process, when a billing scenario is generated, a predetermined alarm screen is displayed on display and operation unit 125, in place of the billing scenario confirmation screen for that billing scenario. This allows the user to readily understand that there is a card (user) of which balance will be insufficient.

Now assume the following case in the billing scenario generating process. The billing pattern B is selected, and the billing scenario as shown in FIG. 13 is generated for a job that is to be performed for three users A, B, and C. According to the generated billing scenario, users A, B, and C are each billed for 500 yen until the job is completed.

The present balance of each user, before execution of the job, is 300 yen for user A, 1200 yen for user B, and 1000 yen for user C. Thus, if a charge is allocated in accordance with the billing scenario, the balance of user A after deducting the charge becomes −200 yen. That is, if the billing is performed in accordance with this billing scenario, the funds in the user A's account will be insufficient to cover the charge. Billing scenario determining unit 159 displays an alarm screen on display and operation unit 125 in such a case that the funds in any user's account are insufficient.

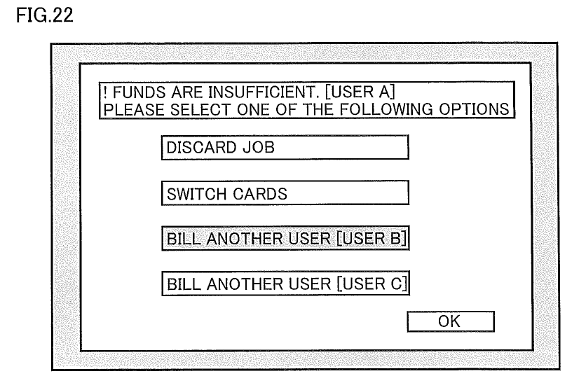

FIG. 22 shows an example of the alarm screen displayed when the funds are insufficient.

The alarm screen includes an alarm display indicating that the funds are insufficient and prompting the user to perform a predetermined operation, and a display of various select buttons which are selectable by the user and an “OK” button (confirm button).

The alarm display includes a display which specifically notifies the user whose balance is insufficient. For example, in the case where the funds in the user A's account are insufficient as described above, the display indicating that the funds are insufficient includes a display which specifically indicates that it is the user A's account in which the balance is insufficient, as shown in FIG. 22.

As the select buttons, those corresponding to the following options are displayed as shown in FIG. 22. The options that can be selected when the funds are insufficient may include: to discard the job to stop printing (“discard job”); to change a combination of cards 90 to be billed (“switch cards”); and to bill another user for the charge that was originally allocated to the user whose balance is insufficient (“bill another user”). Among them, the option to bill another user is set for each user who may be billed. For example, in the case where the funds in the user A's account are insufficient as described above, user B or user C may be billed for the charge that was supposed to be charged to user A. In this case, as shown in FIG. 22, the select buttons are displayed for the option to bill user B (“bill another user [user B]”) and the option to bill user C (“bill another user [user C]”).

The confirm button is pressed for confirming the option that is being selected. On the alarm screen, the user performs an operation of pressing a desired one of the select buttons to select the corresponding option. The user then performs an operation of pressing the confirm button to confirm the selection. When the user presses the confirm button, billing scenario determining unit 159 performs an operation corresponding to the select button confirmed to be selected.

The display indicating that the funds are insufficient may also include a display of the insufficient amount and the like. The billing scenario as shown in FIG. 13 may be displayed as it is, so that the user may understand details about the situation of the insufficient funds.

In the case of switching a person to be billed (“bill another user”), if there is another user whose balance will also be insufficient if the cost is charged thereto, it may be configured not to display the relevant user as a candidate to be billed. This avoids a wasteful select operation, whereby MFP 10 becomes more convenient to use.

The operations that are performed when the funds are insufficient, in accordance with the user's operations, will now be described in conjunction with the above-described example.

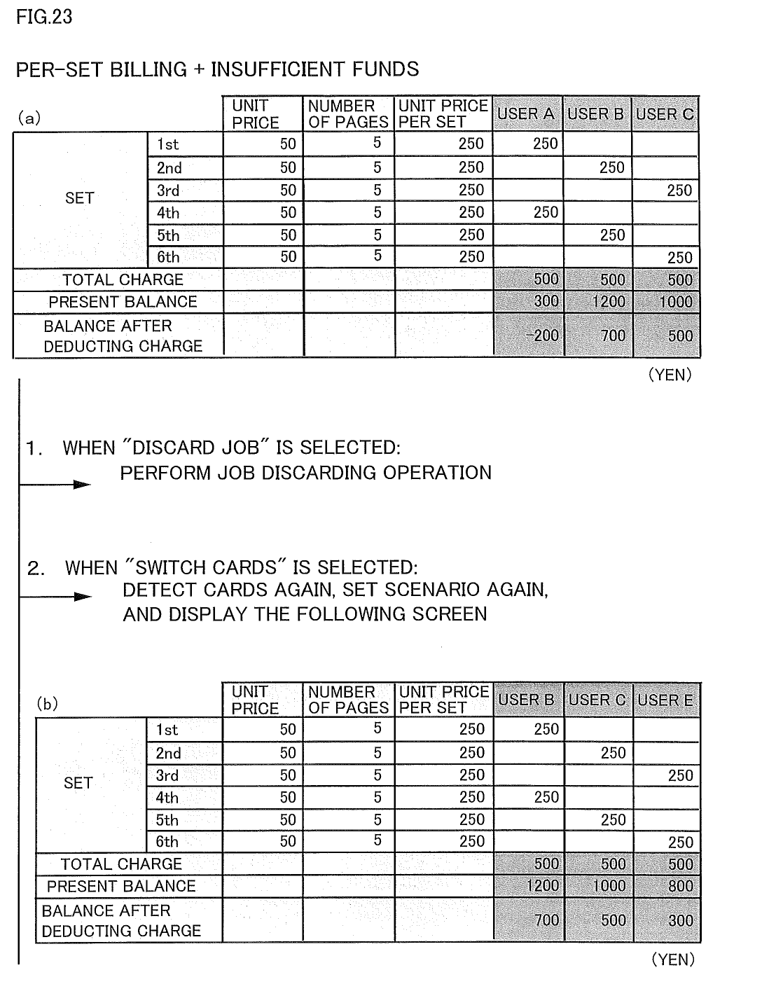

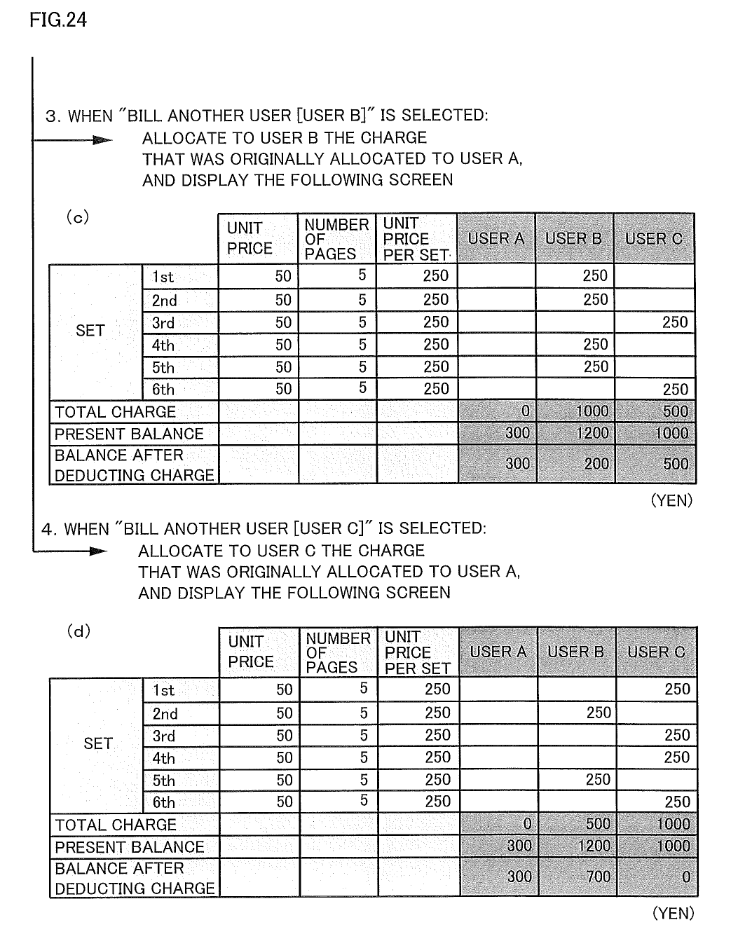

FIGS. 23 and 24 show, by way of example, the operations of MFP 10 performed for handling insufficient funds.

Now assume that a billing scenario is generated with the billing pattern B selected, as described above, and that only the balance of user A is insufficient, as shown in (a) in FIG. 23. At this time, billing scenario determining unit 159 displays on display and operation unit 125 the alarm screen including four select buttons, as shown in FIG. 22, to accept a select operation by the user.

In the case where selection of the select button corresponding to the option “discard job” is confirmed, billing scenario determining unit 159 discards the billing scenario. Billing scenario determining unit 159 notifies job control unit 151 to discard the job. Upon receipt of the notification, job control unit 151 discards the generated job, and thus, execution of the job is stopped. At this time, authenticated-user management unit 153 resets registration of the authenticated users, and waits for the card authentication to be performed again.

Thus, by selecting “discard job”, the user is able to confirm the account balance for each user (each card 90) and take an action, e.g., to reload the balance stored in a card. Alternatively, the user may perform the PC print job registration process again, and perform card authentication again, this time using cards 90 of the users whose balances are sufficient, so that the job can be carried out without causing insufficient funds.

In the case where selection of the select button corresponding to the option “switch cards” is confirmed, billing scenario determining unit 159 discards the billing scenario, and waits for the card authentication to be performed again. At this time, billing scenario determining unit 159 may provide on display and operation unit 125 a display prompting the user to perform card authentication. When the user performs card authentication and the authenticated users are registered in authenticated-user management unit 153, billing scenario determining unit 159 generates a billing scenario for the authenticated users registered at that time. Here, the print job already generated by job control unit 151 is maintained. After billing scenario determining unit 159 generates the billing scenario, it performs the billing approval process provided that no account will suffer insufficient funds due to the billing scenario.

For example, assume that selection of the select button corresponding to the option “switch cards” has been confirmed in the above-described example and that three cards 90 for the users B, C, and E are read and authenticated while billing scenario determining unit 159 is in a standby mode. At this time, billing scenario determining unit 159 generates a billing scenario for the three users. In this case, as shown in (b) in FIG. 23 in the table form, users B, C, and E are each billed for 500 yen in all in accordance with the per-set billing. Each of users B, C, and E has a present balance sufficient enough to cover the allocated charge, so that no account will suffer insufficient funds. Accordingly, billing scenario determining unit 159 displays the billing scenario on display and operation unit 125 in the form of the billing scenario confirmation screen, to perform the billing approval process. When the billing scenario is approved by the user, the job is executed and the charge is billed in accordance with the billing scenario.

Referring now to FIG. 24, in the case where selection of the select button corresponding to the option “bill another user” is confirmed, billing scenario determining unit 159 modifies the billing scenario. The billing scenario is modified such that the user corresponding to the select button is billed instead of the user who was originally billed, as will be described below. At this time, billing scenario determining unit 159 modifies the billing scenario such that the charge that had been allocated to the user whose balance would be insufficient in the billing scenario before modification is allocated to the user corresponding to the select button. The time of billing may remain unchanged before and after modification of the scenario. After modifying the billing scenario, billing scenario determining unit 159 performs the billing approval process provided that no account will suffer insufficient funds according to the modified billing scenario.

For example, assume that selection of the select button corresponding to the option “bill another user [user B]” has been confirmed in the above-described example. In this case, the billing scenario is modified such that a charge is allocated to user B instead of the originally billed user. That is, billing scenario determining unit 159 allocates to user B the charge that was originally allocated to user A whose balance would be insufficient in accordance with the billing scenario before modification (corresponding to the table shown in (a) in FIG. 23). Specifically, in the billing scenario before modification, 250 yen was supposed to be charged to user A twice, after printing of the first set and after printing of the fourth set. In contrast, in the modified billing scenario (corresponding to the table in (c) in FIG. 24), the charge for the first set and that for the fourth set are allocated to user B. That is, in the modified billing scenario, user B is billed for 250 yen each after completion of printing of the first set, the second set, the fourth set, and the fifth set, while user C is billed for 250 yen each after completion of printing of the third set and the sixth set. The user A is billed for no cost. In other words, the charge of 0 yen is allocated to user A. In the modified billing scenario, no account will suffer insufficient funds. Accordingly, billing scenario determining unit 159 displays the modified billing scenario on display and operation unit 125 in the form of the billing scenario confirmation screen, to perform the billing approval process. Once the user approves the billing scenario, the job is executed and the charge is billed.

In the case where the user to be billed is changed to another user as well, the billing scenario is modified in the above-described manner. For example, assume that selection of the select button corresponding to the option “bill another user [user C]” has been confirmed in the above example. In this case, the target to be billed is changed to user C. At this time, billing scenario determining unit 159 allocates to user C the charge that was originally allocated to user A. As a result, in the modified billing scenario (corresponding to the table in (d) in FIG. 24), user C is billed for 250 yen each after completion of printing of the first set, the third set, the fourth set, and the sixth set, while user B is billed for 250 yen each after completion of printing of the second set and the fifth set. The user A is billed for no charge. The present balance of user C is 1000 yen, and thus, if the charge is billed in accordance with the modified billing scenario, the balance of user C after deducting the charge will be 0 yen, which means that there will be no user who suffers insufficient funds. Accordingly, billing scenario determining unit 159 performs the billing approval process for the modified billing scenario. When the user approves the billing scenario, the job is executed and the charge is billed.

The insufficient-funds handling process as described above ensures that a billing scenario which can reliably collect charges is generated for billing. The billing scenario as intended by the user may be re-generated or modified on the basis of the user's selections. This improves the usability of MFP 10, and ensures great user satisfaction. Furthermore, when the card authentication is performed again as described above, the billing scenario may readily be generated, with a group of users different from the one before modification of the scenario being set as the targets to be billed. This further improves the usability of MFP 10.

It may be configured such that billing processing unit 163 or billing scenario determining unit 159 performs the insufficient-funds handling process as appropriate for example when the funds in a certain user's account become actually insufficient and cost cannot be charged thereto during execution of the job.

Alternatively, MFP 10 may be configured not to perform the insufficient-funds handling process. For example, billing processing unit 163 may be configured to permit the balance to take a negative value during the billing process. In this case, MFP 10 may subsequently perform a separate process of requesting the user with the insufficient funds to reload the user's account. Alternatively, the user may reload the user's account (or card 90) in response to a request from an administrator of MFP 10 or an employer of the user.

### EFFECTS OF THE EMBODIMENT

In the MFP configured as described above, a charge is allocated among a plurality of authenticated users who are to be billed. That is, in order to allocate a charge among a plurality of users, it is only necessary to perform card authentication for a plurality of cards corresponding to the users among which the charge is desired to be allocated. This prevents a certain user from being billed for a huge amount, without the need of complicated operations, whereby the MFP becomes more convenient to use.

In particular, during execution of the touch-and-print function, a charge can be allocated among a plurality of users (or cards) which have been authenticated simultaneously. Each of the plurality of users does not have to perform the authentication operation or the PC print job registration process just for the purposes of preventing a single user from being billed unjustly. The job can be executed with simple operations, whereby the benefits of the touch-and-print function are fully enjoyed.

### [Others]

The billing process may be performed by only determining that each user is actually billed for the charge allocated thereto in the billing scenario. For example, during the billing process, each user may be billed for a charge, but the charge does not have to be collected from the user's account immediately. Rather, a total charge allocated to each user or to the user's account during a predetermined period (one month, for example) may be collected therefrom at a time. Still alternatively, an administrator of the MFP or the like may collect the allocated charge, on the basis of a result of the above-described billing operation.

In the billing scenario generating process, billing scenario determining unit 159 may determine, in accordance with a user's select operation, to which card 90 a charge is to be allocated at that time, in a predetermined unit of printing (e.g., per page or per set). This makes it possible to generate more detailed billing scenarios, so that a charge may be billed as desired by the user.

The MFP may be configured to change the number of print copies or the way of printing the job in accordance with the number of authenticated cards or the conditions at the time of card authentication. For example, the MFP may be configured to print the number of pages or the number of sets of copies corresponding to the number of authenticated cards. Furthermore, the MFP may be configured to select a billing pattern in step S01 in FIG. 11 on the basis of the position or the read order of a certain card in the card authentication. For example, the MFP may select the billing pattern that is associated with the user corresponding to the card that has been located closest to (or farthest from) the authentication device upon authentication.

While the card authentication using a contactless card has been described above, the authentication may be performed using another device such as a mobile phone or a card type key (which are other examples of the authentication medium). Further, the user authentication may be performed by biometric authentication, by reading the user's biometric information such as finger print information or vein information (which are other examples of the authentication medium). In this case, for example, one user may perform the PC print job registration process, and a plurality of users may sequentially perform the biometric authentication at an authentication device, so that a charge may be allocated among the authenticated users. Alternatively, the authentication may be performed through input of user ID and password (which are other examples of the authentication medium).

The authentication device may be provided separately from the MFP as described above, or may be built in the MFP. While the billing process is performed by part of the MFP in the above-described embodiment, it may be performed in a billing device that is configured as a separate piece from the MFP. That is, the billing device for the MFP may be built in the MFP or may be provided independently from the MFP. Furthermore, the MFP and an external device may work together to implement the billing device for the MFP.

The billing device according to the present invention is not limited to the one used for the MFP. For example, the present invention is applicable to the billing device used for a black-and-white/color copier, printer, facsimile machine, or a composite machine thereof. Furthermore, the present invention is applicable not only to the billing device used for the image forming device which forms images, but also to the billing device used for the image processing device such as a scanner which reads image data. According to the present invention, a charge levied according to an operation of the image processing device may be allocated among a plurality of authenticated users, or a plurality of authentication media corresponding thereto, so as to prevent a single user from being concentratedly billed for the charge.

The processes in the above embodiment may be performed by software, or may be performed using hardware circuits.

A program for executing the processes in the above embodiment may be provided as well. The program may be recorded on a recording medium such as a CD-ROM, a flexible disk, a hard disk, a ROM, a RAM, or a memory card, which may be provided to a user. The program may be downloaded to the device via a communication line such as the Internet. The processes described above in conjunction with the flowcharts are performed by the CPU and the like in accordance with the program.

According to the present invention, a charge is allocated among a plurality of authentication media which have been detected and determined to be billed. Accordingly, it is possible to provide a billing device for an image processing device which is capable of distributing a charge among a plurality of users without the need of complicated operations, an image processing device which uses the billing device, a method for controlling the billing device for an image processing device, and a program for controlling the billing device for an image processing device.

It should be understood that the embodiments described above are illustrative and non-restrictive in every respect. The scope of the present invention is defined by the terms of the claims, rather than the description above, and is intended to include any modifications within the scope and meaning equivalent to the terms of the claims.

What is claimed is:

1. A billing device for an image processing device, the billing device performing an accounting process in relation to an operation of the image processing device, the billing device comprising:
a determining unit configured to determine that a plurality of authentication media have been detected simultaneously or within a predetermined period of time; and
an allocating unit configured to allocate, among the plurality of authentication media determined to be detected by said determining unit, a predetermined charge levied according to the operation of said image processing device.

2. The billing device for an image processing device according to claim 1, the billing device further comprising a billing unit configured to bill each one of said plurality of authentication media for the charge allocated thereto by said allocating unit.

3. The billing device for an image processing device according to claim 1, the billing device further comprising an authentication unit configured to perform authentication for said authentication media determined to be detected, wherein
said allocating unit allocates, among the authentication media authenticated by said authentication unit, the predetermined charge levied according to the operation of said image processing device, the operation being executed after said authentication is performed by said authentication unit.

4. The billing device for an image processing device according to claim 1, wherein said allocating unit allocates said predetermined charge equally among said authentication media.

5. The billing device for an image processing device according to claim 1, wherein said allocating unit performs said allocation in accordance with a predetermined billing ratio set for each of said authentication media.

6. The billing device for an image processing device according to claim 5, the billing device further comprising a changing unit configured to change said predetermined billing ratio used for said allocation, in accordance with a setting by a user.

7. The billing device for an image processing device according to claim 1, the billing device further comprising a display unit configured to display, on a display provided in the billing device or on a display provided in an external device, the charge allocated to each of said plurality of authentication media by said allocating unit.

8. The billing device for an image processing device according to claim 1, wherein
a use limit for a function of the image processing device is set for each authentication medium, and
said allocating unit performs said allocation on the basis of said use limit set for each of said authentication media determined to be detected.

9. The billing device for an image processing device according to claim 1, wherein in the case where said determining unit determines that another authentication medium has been additionally detected within a predetermined period of time from when said allocating unit started the allocating process, said allocating unit performs said allocation for said other authentication medium as well.

10. The billing device for an image processing device according to claim 1, the billing device further comprising an alarm unit configured to issue a predetermined alarm in the case where the alarm unit detects that a balance in at least one of the authentication media will be insufficient when each of said authentication media is billed for the charge allocated thereto by said allocating unit.

11. The billing device for an image processing device according to claim 1, wherein said allocating unit allocates said predetermined charge in a unit of page to be output or in a unit of set to be output, sequentially to each of the authentication media.

12. The billing device for an image processing device according to claim 1, wherein said allocating unit determines to which of said authentication media said allocation is to be performed in a unit of page to be output or in a unit of set to be output.

13. The billing device for an image processing device according to claim 11, wherein in the case where the number of pages to be output cannot be evenly distributed among said authentication media determined to be detected and, hence, there is the remainder of the pages, said allocating unit allocates the charge for said remainder to a predetermined one of said plurality of authentication media.

14. The billing device for an image processing device according to claim 12, wherein in the case where the number of sets of copies to be output cannot be evenly distributed among said authentication media determined to be detected and, hence, there is the remainder of the sets of copies, said allocating unit allocates the charge for said remainder to a predetermined one of said plurality of authentication media.

15. The billing device for an image processing device according to claim 1, wherein
said billing device for an image processing device is connected to a detecting device for detecting an authentication medium, and
said determining unit determines that said plurality of authentication media have been detected by said detecting device.

16. An image processing device comprising the billing device for an image processing device according to claim 1.

17. A method for controlling a billing device for an image processing device, the billing device performing an accounting process in relation to an operation of the image processing device, the method comprising the steps of:
determining that a plurality of authentication media have been detected simultaneously or within a predetermined period of time; and
allocating, among the plurality of authentication media determined to be detected in said determining step, a predetermined charge levied according to the operation of said image processing device.

18. The method for controlling a billing device for an image processing device according to claim 17, wherein said allocating step includes the step of allocating said predetermined charge equally among said authentication media.

19. The method for controlling a billing device for an image processing device according to claim 17, wherein said allocating step includes the step of performing said allocation in accordance with a predetermined billing ratio set for each of said authentication media.

20. A program for controlling a billing device for an image processing device, the billing device performing an accounting process in relation to an operation of the image processing device, the program being stored in a computer readable medium and causing a computer to execute processing comprising the steps of:
determining that a plurality of authentication media have been detected simultaneously or within a predetermined period of time; and
allocating, among the plurality of authentication media determined to be detected in said determining step, a predetermined charge levied according to the operation of said image processing device.
